(19) United States
(12) Patent Application Publication
(10) Pub. No.: US 2023/0408988 A1
(43) Pub. Date: Dec. 21, 2023

(54) SYSTEMS AND METHODS FOR AUTOMATED CONTROL OF AN INDUSTRIAL PROCESS

(71) Applicant: OnPoint Technologies, LLC, Wichita, KS (US)

(72) Inventors: Thomas Korb, Owasso, OK (US); Chad Carroll, Tulsa, OK (US); Jose Corcega, Tulsa, OK (US); Kevin Cooper, Wichita, KS (US); Junda Zhu, Tulsa, OK (US); Mark Vaccari, Broken Arrow, OK (US)

(21) Appl. No.: 18/037,785

(22) PCT Filed: Nov. 16, 2021
(86) PCT No.: PCT/IB2021/060612

§ 371 Date: May 19, 2023

Related U.S. Application Data
(60) Provisional application No. 63/116,172, filed on Nov. 20, 2020.

(51) Int. Cl. G05B 13/02

(52) U.S. Cl. CPC G05B 13/028

(57) ABSTRACT

A system for automated control of an industrial process system, comprising: a data historian storing measured process data sensed by a plurality of sensors within the industrial process system; a processor; and, memory storing a control engine as computer readable instructions that, when executed by the processor, cause the processor to: receive an artificial intelligence control setpoint for controlling an operating condition of the industrial process system; compare the artificial intelligence control setpoint to a static threshold and a dynamic threshold; and output a control signal, to manipulate the operating condition, as one of the artificial intelligence control setpoint, the static threshold, or the dynamic threshold based on a relationship of the artificial intelligence control setpoint to the static threshold or dynamic threshold.

### CROSS REFERENCE TO RELATED APPLICATIONS

This application claims priority to and the benefit of U.S. Provisional Patent Application No. 63/116,172, filed Nov. 20, 2020, the disclosure of which is incorporated herein by reference in its entirety.

### BACKGROUND

Industrial processes include many types of sensors that provide sensed data to a data historian. Such data may then be used to control the industrial processes (such as via proportional-integral-derivative (PID) controllers, a distributed control system, human operator analysis of the sensed data, etc.). For example, in a combustion system, sensors collect data within a process heater that utilizes burners to convert fuel and air into thermal energy. The sensors may be used to provide insights within the process heater

### SUMMARY

In a first aspect, a system for automated control of an industrial process system, includes: a data historian storing measured process data sensed by a plurality of sensors within the industrial process system; a processor; and, memory storing a control engine as computer readable instructions that, when executed by the processor, cause the processor to: receive an artificial intelligence control setpoint for controlling an operating condition of the industrial process system, compare the artificial intelligence control setpoint to a static threshold and a dynamic threshold, output a control signal, to manipulate the operating condition, as one of the artificial intelligence control setpoint, the static threshold, or the dynamic threshold based on a relationship of the artificial intelligence control setpoint to the static threshold or dynamic threshold.

In an embodiment of a second aspect, a method for automated control of an industrial process system includes: receiving an artificial intelligence control setpoint for controlling an operating condition of the industrial process system, comparing the artificial intelligence control setpoint to a static threshold and a dynamic threshold, outputting a control signal, to manipulate the operating condition, as one of the artificial intelligence control setpoint, the static threshold, or the dynamic threshold based on a relationship of the artificial intelligence control setpoint to the static threshold or dynamic threshold.

### BRIEF DESCRIPTION OF THE FIGURES

The foregoing and other features and advantages of the disclosure will be apparent from the more particular description of the embodiments, as illustrated in the accompanying drawings, in which like reference characters refer to the same parts throughout the different figures. The drawings are not necessarily to scale, emphasis instead being placed upon illustrating the principles of the disclosure.

FIG. 1 depicts an example system of a process heater with automatic air register setting determination, in embodiments.

FIG. 2 depicts a typical draft profile throughout the example heater of FIG. 1, in embodiments.

FIG. 3 depicts a plurality of example process tube types, in embodiments.

FIG. 4 depicts a diagram showing air temperature and humidity effects on sensed excess O₂ levels, in embodiments.

FIG. 5 depicts a schematic of air and fuel mixture in a pre-mix burner, in embodiments.

FIG. 6 depicts a schematic of air and fuel mixture in a diffusion burner, in embodiments.

FIG. 7 depicts an example cutaway diagram of a burner, which is an example of the burner of FIG. 1, in embodiments.

FIG. 8 depicts an example air register handle and indicator plate that is manually controlled, in embodiments.

FIG. 9 depicts example burner tips with different shapes and sizes, in embodiments.

FIG. 10 depicts example burner tips with the same shape, but different drill hole configurations, in embodiments.

FIG. 11 depicts a block diagram of the example process controller of FIG. 1 in further detail, in embodiments.

FIGS. 12-16 depict various operating conditions resulting in sensed oxygen readings by the example oxygen sensor of FIG. 1 that cause incorrect control of the input fuel/air ratio to the example burner of FIG. 1, in embodiments.

FIG. 17 depicts a combustion system controller for automated control of a combustion system, in embodiments.

FIG. 18 shows an example comparison, made by the control engine of FIG. 17, of the artificial intelligence control set point, to the static threshold and the dynamic threshold to generate the control signal, in embodiments.

FIG. 19 shows an example of the output control signal based on the data of FIG. 18, in embodiments.

FIG. 20 is a flowchart illustrating a method for automated control of a combustion system, in embodiments.

### DETAILED DESCRIPTION OF THE EMBODIMENTS

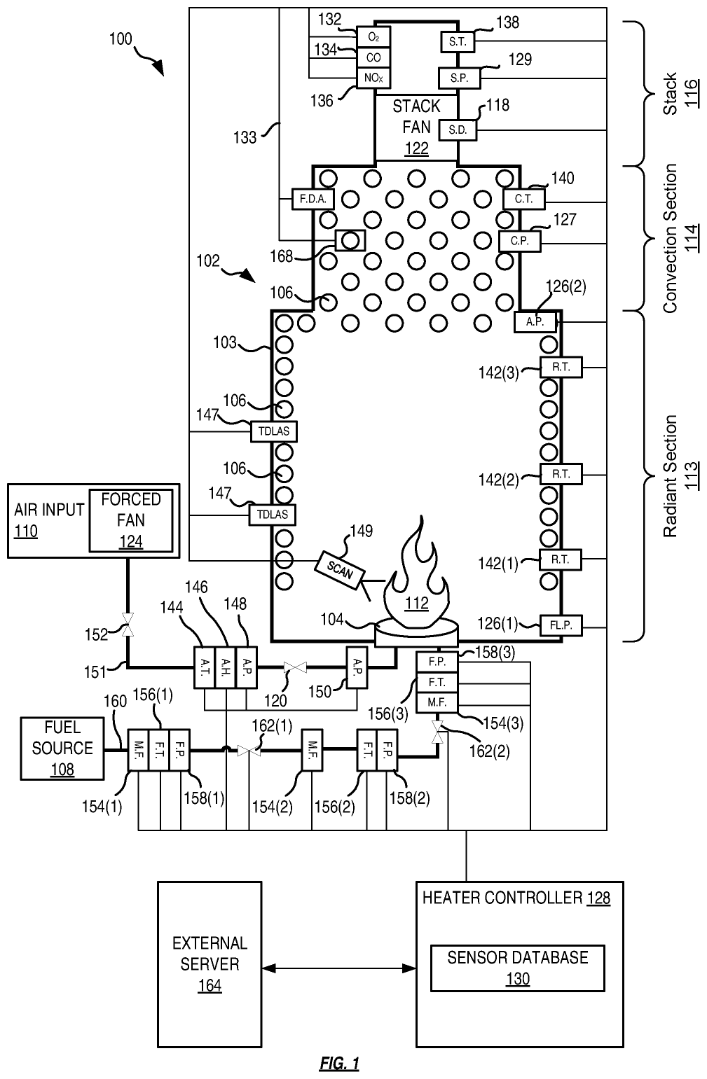

FIG. 1 depicts an example system 100 of a process heater with an intelligent monitoring system, in embodiments. The system 100 includes a heater 102 that is heated by one or more burners 104 located in the housing 103 thereof. Heater 102 can have any number of burners 104 therein, each operating under different operating conditions (as discussed in further detail below). Moreover, although FIG. 1 shows a burner 104 located on the floor of the heater 102, one or more burners 104 may also be located on the walls and/or ceiling of the heater 102 without departing from the scope hereof (indeed, heaters in the industry often have over 100 burners). Further, the heater 102 may have different configurations, for example a box heater, a cylindrical heater, a cabin heater, and other shapes, sizes, etc., as known in the art.

Burner 104 provides heat necessary to catalyze chemical reactions or heat up process fluid in one or more process tubes 106 (not all of which are labeled in FIG. 1). Any number of process tubes 106 may be located within the heater 102, and in any configuration (e.g., horizontal, vertical, curved, off-set, slanted, or any configuration thereof). Burner 104 is configured to combust a fuel source 108 with an oxidizer such as air input 110 to convert the chemical energy in the fuel into thermal energy 112 (e.g., a flame). This thermal energy 112 then radiates to the process tubes 106 and is transferred through the process tubes 106 into a material therein that is being processed. Accordingly, the heater 102 typically has a radiant section 113, a convection section 114, and a stack 116. Heat transfer from the thermal energy 112 to the process tubes 106 primarily occurs in the radiant section 113 and the convection section 114.

Airflow into the heater 102 (through the burner 104) typically occurs in one of four ways natural, induced, forced, and balanced.

A natural induced airflow draft occurs via a difference in density of the flue gas inside the heater 102 caused by the combustion. There are no fans associated in a natural induced system. However, the stack 116 includes a stack damper 118 and the burner includes a burner air register 120 that are adjustable to change the amount of naturally induced airflow draft within the heater 102.

An induced airflow draft system includes a stack fan (or blower) 122 located in the stack 116 (or connected to the stack) 116. In other or additional embodiments, other motive forces than a fan can be used to create the induced draft, such as steam injection to educts flue gas flow through the heater. The stack fan 122 operates to pull air through the burner air register 120 creating the induced-draft airflow within the heater 102. The stack fan 122 operating parameters (such as the stack fan 122 speed and the stack damper 118 settings) and the burner air register 120 impact the draft airflow. The stack damper 118 may be a component of the stack fan 122, or separate therefrom.

A forced-draft system includes an air input forced fan 124 that forces air input 110 into the heater 102 via the burner 104. The forced fan 124 operating parameters (such as the forced fan 124 speed and the burner air register 120 settings) and the stack damper 118 impact the draft airflow. The burner air register 120 may be a component of the forced fan 124, but is commonly separate therefrom and a component of the burner 104.

A balanced-draft system includes both the air input forced fan 124 and the stack fan 122. Each fan 122, 124 operate in concert, along with the burner air register 120 and stack damper 118 to control the airflow and draft throughout the heater 102.

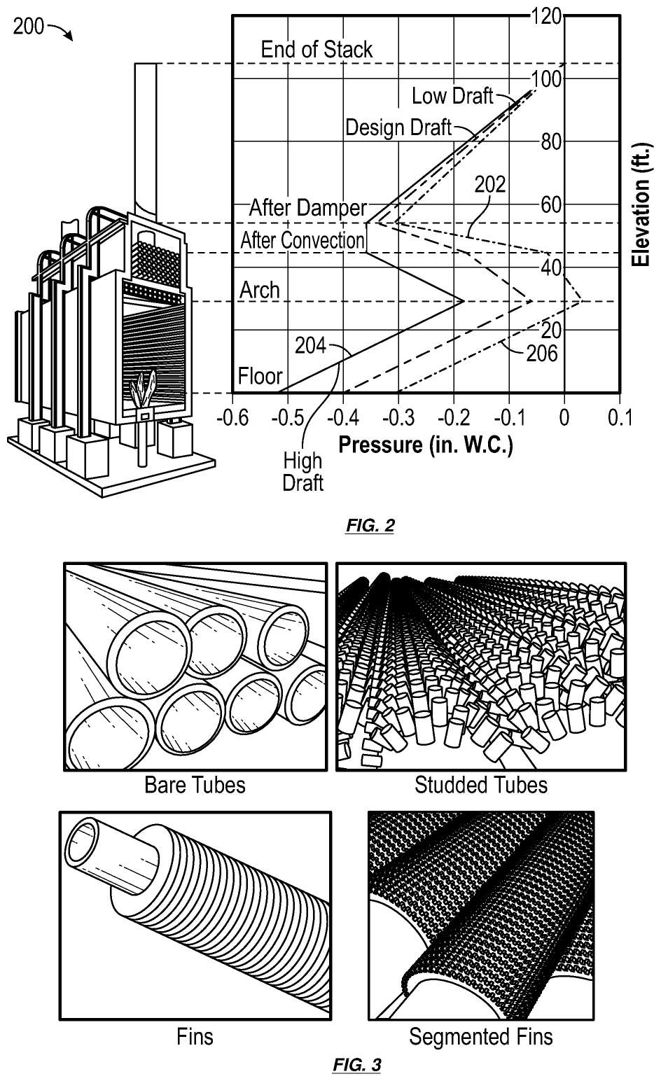

Draft throughout the heater 102 varies depending on the location within the heater 102. FIG. 2 depicts a typical draft profile 200 throughout a heater (e.g., heater 102). Line 202 depicts a desired draft that is consistent with the design of the heater 102 and components therein. Line 204 depicts a high draft situation where pressure in the heater is lower than desired (and thus lower when compared to atmospheric pressure outside of the heater). Line 206 depicts a low draft situation where pressure in the heater is higher than desired (and thus closer to or greater than atmospheric pressure outside of the heater). As shown, by line 202, heaters are often designed to have roughly a −0.1 pressure at the arch of the heater.

Draft throughout the heater 102 is also be impacted based on the geometry of the heater and components thereon. For example, draft is strongly a function of heater 102 height. The taller the heater 102, the more negative the draft will be at the floor of the heater 102 to maintain the same draft level at the top of the heater 102 (normally −0.1 in H₂O). The components greatly impact the draft. For example, FIG. 3 depicts a plurality of process tube types 300, including bare tubes, studded tubes, fin tubes, and segmented tubes. The convection section process tubes 106 may or may not have heat sink fins thereon to manage the heat transfer from the thermal energy 112 to the process tube 106. These convection section fins may plug or corrode overtime, varying the required draft within a heater as compared to the designed draft for the same heater with the same components. As the convection section flue gas channel open area begins to decrease, a greater pressure differential is required to pull the same quantity of flue gas through the convection section.

Referring to FIG. 1, pressure (indicating draft) within the heater 102 is measured at a variety of locations in the heater respectively via one of a plurality of pressure sensors. Floor pressure sensor 126(1) measures the pressure at the floor of the heater 102. Arch pressure sensor 126(2) measures the pressure at the arch of the heater 102 where the radiant section 113 transitions to the convection section 114. Convection pressure sensor 127 measures the pressure of the convection section 114. Stack pressure sensor 129, if included, measures the pressure of the stack 116.

The pressure sensors 126, 127, 129 may include a manometer, or a Magnehelic draft gauge, where the pressure readings are manually entered into process controller 128 (or a handheld computer and then transferred wirelessly or via wired connection from the handheld computer to the process controller 128) including a sensor database 130 therein storing data from various components associated with the heater 102. The pressure sensors 126, 127, 129 may also include electronic pressure sensors and/or draft transmitters that transmit the sensed pressure to the process controller 128 via a wired or wireless connection 133. The wireless or wired connection 133 may be any communication protocol, including Wi-Fi, cellular, CAN bus, etc.

The process controller 128 is a distributed control system (DCS) (or plant control system (PLC) used to control various systems throughout the system 100, including fuel-side control (e.g., control of components associated with getting fuel source 108 into the heater 102 for combustion therein), air-side control (e.g., control of components associated with getting air input 110 into the heater 102), internal combustion-process control (e.g., components associated with managing production of the thermal energy 112, such as draft within the heater 102), and post-combustion control (e.g., components associated with managing the emissions after production of the thermal energy 112 through the stack 116). The process controller 128 typically includes many control loops, in which autonomous controllers are distributed throughout the system 100 (associated with individual or multiple components thereof), and including a central operator supervisory control.

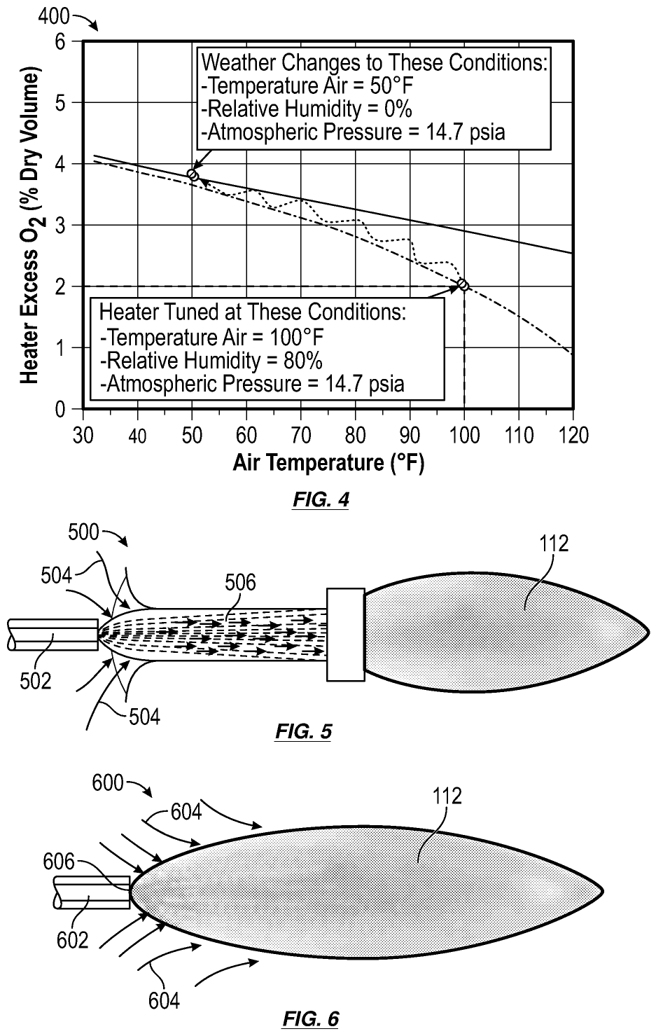

Operating conditions within the heater 102 (such as draft, and the stoichiometry associated with creating the thermal energy 112) are further impacted via atmospheric conditions, such as wind, wind direction, humidity, ambient air temperature, sea level, etc. FIG. 4 depicts a diagram 400 showing air temperature and humidity effects on sensed excess O₂ levels. The changes in operating conditions are often controlled by monitoring and manipulating the draft conditions within the heater 102. The stack dampers 118 are commonly digitally controlled, and therefore often controllable from the operating room of the system 100, via the process controller 128. However, many systems do not include burner air registers 120 that are digitally controlled. Because of this, system operators often control draft within the heater 102 using just an electronic stack damper (e.g., stack damper 118) thereby avoiding timely and costly manual operation of each burner air register (e.g., burner air register 120) associated with each individual burner (e.g., burner 104). This cost grows depending on the number of burners located in each heater—each heater may have over 100 burners therein.

In addition to the draft as discussed above, burner geometry plays a critical role in managing the thermal energy 112 produced in the heater 102. Each burner 104 is configured to mix the fuel source 108 with the air input 110 to cause combustion and thereby create the thermal energy 112. Common burner types include pre-mix burners and diffusion burners. FIG. 5 depicts a schematic 500 of air and fuel mixture in a pre-mix burner, in embodiments. In a pre-mix burner, kinetic energy of the fuel gas 502 draws some primary air 504 needed for combustion into the burner. The fuel and air mix to create an air/fuel mixture 504 having a specific air-to-fuel ratio prior to igniting to create the thermal energy 112. FIG. 6 depicts a schematic 600 of air and fuel mixture in a diffusion burner, in embodiments. In a diffusion burner, air 604 for combustion is drawn (by induced- or natural-draft) or pushed (by forced-, or balanced-draft) into the heater before mixing with the fuel 602. The mixture burns at the burner gas tip 606.

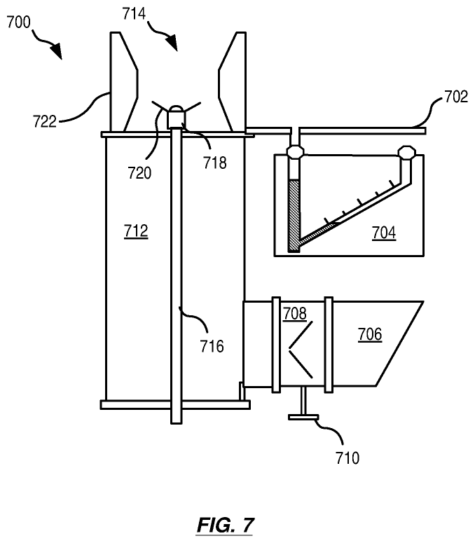

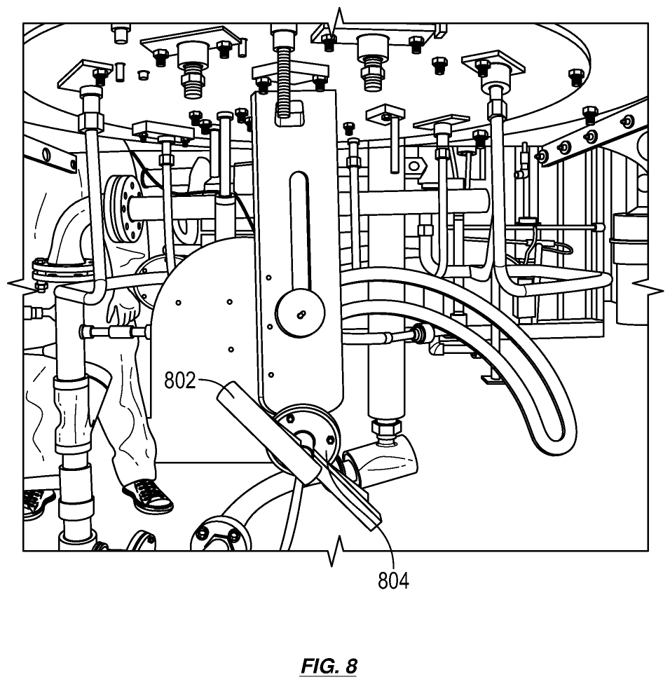

FIG. 7 depicts an example cutaway diagram of a burner 700, which is an example of the burner 104 of FIG. 1. Burner 700 is an example of a diffusion burner. Burner 700 is shown mounted in a heater at the heater floor 702. Proximate the burner 700 in the heater floor 702 is a manometer 704, which is an example of the pressure sensors 126, 127, 129 discussed above. The manometer 704 may be another type of pressure sensor without departing from the scope hereof. Burner 700 is shown for a natural or induced-draft heater system, and includes a muffler 706 and a burner air register 708. Ambient air flows through the muffler 706 from outside the heater system. In a forced or balanced-draft system, the muffler 706 may not be included and instead be replaced with an intake ducting from the forced fan (e.g., forced fan 124 in FIG. 1). The burner air register 708 is an example of the burner air register 120 discussed above with respect to FIG. 1, and may be manipulated via an air register handle 710 to one of a plurality of settings defining how open or closed the air register 708 is. As discussed above, the air register handle 710 is typically manually controlled (although sometimes is fitted with an actuator, or provided with mechanical linkage and an actuator so a single actuator manipulates a plurality of burners). FIG. 8 depicts an example air register handle 802 and indicator plate 804 that is manually controlled. The input air then travels through the burner plenum 712 towards the burner output 714 where it is mixed with input fuel and ignited to combust and produce thermal energy (e.g., thermal energy 112 of FIG. 1).

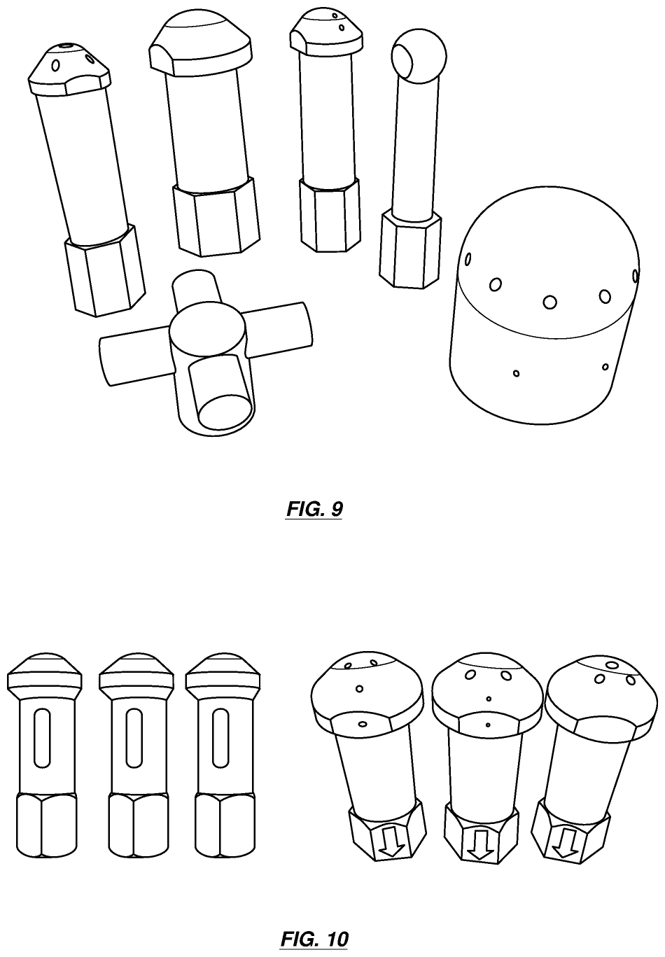

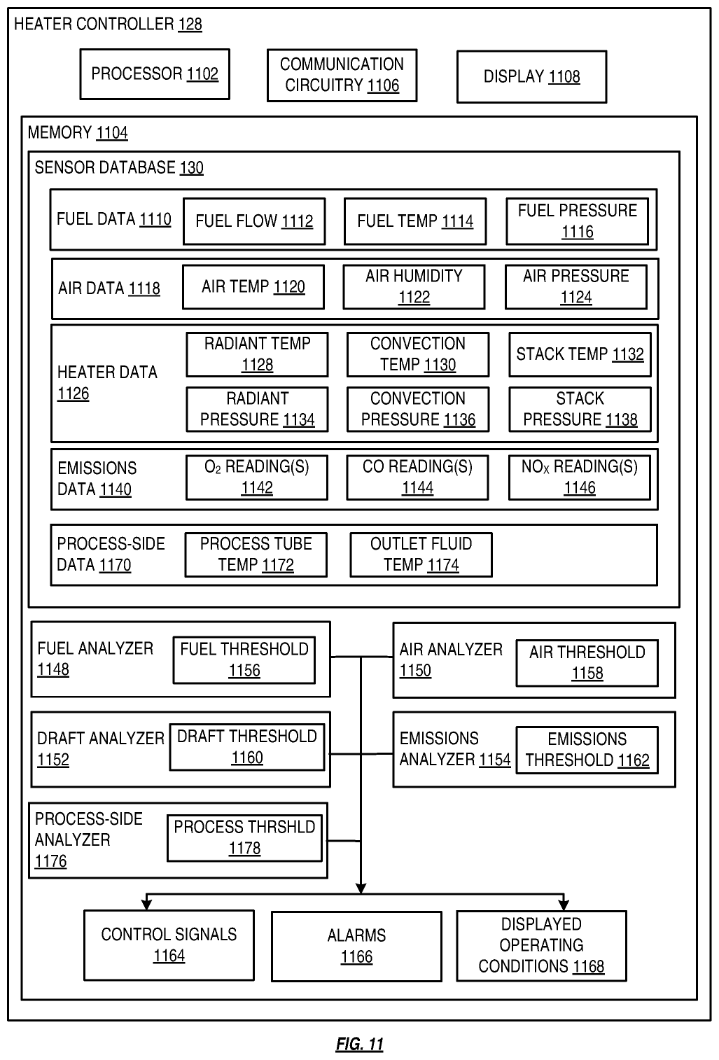

The fuel travels through a fuel line 716, and is output at a burner tip 718. The fuel may be disbursed on a deflector 720. The burner tip 718 and deflector 720 may be configured with a variety of shapes, sizes, fuel injection holes, etc. to achieve the desired combustion results (e.g., flame shaping, emissions tuning, etc.). FIG. 9 depicts example burner tips with different shapes and sizes. FIG. 10 depicts example burner tips with the same shape, but different drill hole configurations. Furthermore, one or more tiles 722 may be included at the burner output 714 to achieve a desired flame shape or other characteristic.

Referring to FIG. 1, control of the system 100 occurs both manually and digitally. As discussed above, various components, such as burner air register 120 are commonly manually controlled. However, the system 100 also includes a variety of sensors throughout the heater 102, the fuel-side input, and the air-side input used to monitor and control the system using the process controller 128.

At the stack 116, an oxygen sensor 132, a carbon monoxide sensor 134, and NO_{X} sensor 136 can be utilized to monitor the condition of the exhaust and emissions leaving the heater 102 via the stack 116. Each of the oxygen sensor 132, carbon monoxide sensor 134, and NO_{X} sensor 136 may be separate sensors, or part of a single gas-analysis system. The oxygen sensor 132, carbon monoxide sensor 134, and NOₓ sensor 136 are each operatively coupled to the process controller 128 via a wired or wireless communication link. These sensors indicate the state of combustion in the heater 102 in substantially real-time. Data captured by these sensors is transmitted to the process controller 128 and stored in the sensor database 130. By monitoring the combustion process represented by at least one of the oxygen sensor 132, carbon monoxide sensor 134, and NOₓ sensor 136, the system operator may adjust the process and combustion to stabilize the heater 102, improve efficiency, and/or reduce emissions. In some examples, other sensors, not shown, can be included to monitor other emissions (e.g., combustibles, methane, sulfur dioxide, particulates, carbon dioxide, etc.) on a real-time basis to comply with environmental regulations and/or add constraints to the operation of the process system. Further, although the oxygen sensor 132, carbon monoxide sensor 134, and NOₓ sensor 136 are shown in the stack 116, there may be additional oxygen sensor(s), carbon monoxide sensor(s), and NO_{X} sensor(s) located elsewhere in the heater 102, such as at one or more of the convection section 114, radiant section 113, and/or arch of the heater 102. The above discussed sensors in the stack section may include a flue gas analyzer (not shown) prior to transmission to the process controller 128 that extract, or otherwise test, a sample of the emitted gas within the stack 116 (or other section of the heater) and perform an analysis on the sample to determine the associated oxygen, carbon monoxide, or NOₓ levels in the sample (or other analyzed gas). Other types of sensors include tunable laser diode absorption spectroscopy (TDLAS) systems that determine the chemical composition of the gas based on laser spectroscopy.

Flue gas temperature may also be monitored by the process controller 128. To monitor the flue gas temperatures, the heater 102 may include one or more of a stack temperature sensor 138, a convection sensor temperature sensor 140, and a radiant temperature sensor 142 that are operatively coupled to the process controller 128. Data from the temperature sensors 138, 140, 142 are transmitted to the process controller 128 and stored in the sensor database 130. Further, each section may have a plurality of temperature sensors—in the example of FIG. 1, there are three radiant section temperature sensors 142(1)-(3). The above discussed temperature sensors may include a thermocouple, suction pyrometer, and/or laser spectroscopy analysis systems that determine the temperature associated with the given temperature sensor.

The process controller 128 may further monitor air-side measurements and control airflow into the burner 104 and heater 102. Air-side measurement devices include an air temperature sensor 144, an air-humidity sensor 146, a pre-burner air register air pressure sensor 148, and a post-burner air register air pressure sensor 150. In embodiments, the post-burner air pressure is determined based on monitoring excess oxygen readings in the heater 102. The air-side measurement devices are coupled within or to the air-side ductwork 151 to measure characteristics of the air flowing into the burner 104 and heater 102. The air-temperature sensor 144 may be configured to sense ambient air temperatures, particularly for natural and induced-draft systems. The air-temperature sensor 144 may also be configured to detect air temperature just prior to entering the burner 104 such that any pre-heated air from an air-preheat system is taken into consideration by the process controller 128. The air-temperature sensor 144 may be a thermocouple, suction pyrometer, or any other temperature measuring device known in the art. The air humidity sensor 146 may be a component of the air temperature sensor, or may be separate therefrom, and is configured to sense the humidity in the air entering the burner 104. The air temperature sensor 144 and air humidity sensor 146 may be located upstream or downstream from the burner air register 120 without departing from the scope hereof. The pre-burner air register air pressure sensor 148 is configured to determine the air pressure before the burner air register 120. The post-burner air register air pressure sensor 150 is configured to determine the air pressure after the burner air register 120. The post-burner air register air pressure sensor 150 may not be a sensor measuring the furnace draft at the burner elevation, or other elevation and then calculated to determine the furnace draft at the burner elevation. Comparisons between the post-burner air register air pressure sensor 150 and the pre-burner air register air pressure sensor 148 may be made by the process controller to determine the pressure drop across the burner 104, particularly in a forced-draft or balanced-draft system. Air-side and temperature measurements discussed herein may further be measured using one or more TDLAS devices 147 located within the heater 102 (at any of the radiant section 113, convection section 114, and/or stack 116).

Burner 104 operational parameters may further be monitored using a flame scanner 149. Flame scanners 149 operate to analyze frequency oscillations in ultraviolet and/or infrared wavelengths of one or both of the main burner flame or the burner pilot light.

FIG. 1 also shows an air handling damper 152 that is located prior to the burner air register 120. The air-handling damper 152 includes any damper that impacts air-flow into the heater 102, such as a duct damper, variable speed fan, fixed-speed fan with air throttling damper, etc.) In certain system configurations, a single air input 110 (including a given forced fan 124) supplies air to a plurality of burners, or a plurality of zones within a given heater. There may be any number of fans (e.g., forced fan 124), temperature sensors (e.g., air temperature sensor 144), air humidity sensors (e.g., air humidity sensor 146), air pressure sensors (e.g., pre-burner air register air pressure sensor 148) for a given configuration. Further, any of these air-side sensors maybe located upstream or downstream from the air handling damper 152 without departing form the scope hereof.

The process controller 128 may further monitor fuel-side measurements and control fuel flow into the burner 104. Fuel-side measurement devices include one or more of flow sensor 154, fuel temperature sensor 156, and fuel-pressure sensor 158. The fuel-side measurement devices are coupled within or to the fuel supply line(s) 160 to measure characteristics of the fuel flowing into the burner 104. The flow sensor 154 may be configured to sense flow of the fuel through the fuel supply line 160. The fuel-temperature sensor 156 detects fuel temperature in the fuel supply line 160, and includes known temperature sensors such as a thermocouple. The fuel-pressure sensor 158 detects fuel-pressure in the fuel supply line 160.

The fuel line(s) 160 may have a plurality of fuel control valves 162 located thereon. These fuel control valves 162 operate to control the flow of fuel through the fuel supply lines 160. The fuel control valves 162 are typically digitally controlled via control signals generated by the process controller 128. FIG. 1 shows a first fuel control valve 162(1) and a second fuel control valve 162(2). The first fuel control valve 162(1) controls fuel being supplied to all burners located in the heater 102. The second fuel control valve 162(2) controls fuel being supplied to each individual burner 104 (or a grouping of burners in each heater zone). There may be more or fewer fuel control valves 162 without departing from the scope hereof. Further, as shown, there may be a grouping of fuel-side measurement devices between individual components on the fuel supply line 160. For example, a first flow sensor 154(1), first fuel temperature sensor 156(1), and first fuel-pressure sensor 158(1) are located on the fuel supply line 160 between the fuel source 108 and the first fuel control valve 162(1). A second flow sensor 154(2), second fuel temperature sensor 156(2), and second fuel-pressure sensor 158(2) are located on the fuel supply line 160 between the first fuel control valve 162(1) and the second fuel control valve 162(2). Additionally, a third flow sensor 154(3), third fuel temperature sensor 156(3), and third fuel-pressure sensor 158(3) are located on the fuel supply line 160 between the second fuel control valve 162(2) and the burner 104. The third fuel temperature sensor 156(3), and third fuel-pressure sensor 158(3) may be configured to determine flow, temperature, and pressure respectively of an air/fuel mixture for pre-mix burners discussed above with respect to FIG. 5.

The process controller 128 may also measure process-side temperatures associated with the processes occurring within the process tubes 106. For example, system 100 may further include one or more tube temperature sensors 168, such as a thermocouple, that monitor the temperature of the process tubes 106. The temperature sensor 168 may also be implemented using optical scanning technologies, such as an IR camera, and/or one of the TDLAS devices 147. Furthermore, the heater controller 128 may also receive sensed outlet temperature of the fluid within the process tubes 106 from process outlet temperature sensor (not shown), such as a thermocouple. The process controller 128 may then use these sensed temperatures (from the tube temperature sensors 168 and/or the outlet temperature sensor) to control firing rate of the burners 104 to increase or decrease the generated thermal energy 112 to achieve a desired process temperature.

FIG. 11 depicts a block diagram of the process controller 128 of FIG. 1 in further detail, in embodiments. The process controller 128 includes a processor 1102 communicatively coupled with memory 1104. The processor 1102 may include a single processing device or a plurality of processing devices operating in concert. The memory 1104 may include transitory and or non-transitory memory that is volatile and/or non-volatile.

The process controller 128 may further include communication circuitry 1106 and a display 1108. The communication circuitry 1106 includes wired or wireless communication protocols known in the art configured to receive and transmit data from and to components of the system 100. The display 1108 may be co-located with the process controller 128, or may be remote therefrom and displays data about the operating conditions of the heater 102 as discussed in further detail below.

Memory 1104 stores the sensor database 130 discussed above, which includes any one or more of fuel data 1110, air data 1118, heater data 1126, emissions data 1140, process-side data 1170, and any combination thereof. In embodiments, the sensor database 130 includes fuel data 1110. The fuel data 1110 includes fuel flow 1112, fuel temperature 1114, and fuel-pressure data 1116 readings throughout the system 100 regarding the fuel being supplied to the burner 104. For example, the fuel flow data 1112 includes sensed readings from any one or more of the flow sensor(s) 154 in system 100 transmitted to the process controller 128. The fuel temperature data 1114 includes sensed readings from any one or more of the fuel temperature sensor(s) 156 in system 100 transmitted to the process controller 128. The fuel-pressure data 1116 includes sensed readings from any one or more of the fuel-pressure sensor(s) 158 in system 100 transmitted to the process controller 128. In embodiments, the fuel data 1110 may further include fuel composition information that is either sensed via a sensor located at the fuel source 108 or that is determined based on an inferred fuel composition such as that discussed in U.S. Provisional Patent Application No. 62/864,954, filed Jun. 21, 2019 and which is incorporated by reference herein as if fully set forth. The fuel data 1110 may also include data regarding other fuel-side sensors not necessarily shown in FIG. 1, but known in the art.

In embodiments, the sensor database 130 includes air data 1118 regarding the air being supplied to the burner 104 and heater 102. The air data 1118 includes air temperature data 1120, air humidity data 1122, and air pressure data 1124. The air temperature data 1120 includes sensed readings from any one or more of the air temperature sensor(s) 144 in system 100 transmitted to the process controller 128. The air humidity data 1122 includes sensed readings from any one or more of the air humidity sensor(s) 146 in system 100, and/or data from local weather servers, transmitted to the process controller 128. The air pressure data 1124 includes sensed readings from any one or more of the pre-burner air register air pressure sensor 148, and a post-burner air register air pressure sensor 150 (or any other air pressure sensor) in system 100 transmitted to the process controller 128. The air data 1118 may also include data regarding other air-side sensors not necessarily shown in FIG. 1, but known in the art.

In embodiments, the sensor database 130 includes heater data 1126. The heater data 1126 includes radiant-section temperature data 1128, convection-section temperature data 1130, stack-section temperature data 1132, radiant-section pressure data 1134, convection-section pressure data 1136, and stack-section pressure data 1138. The radiant-section temperature data 1128 includes sensed readings from the radiant temperature sensor(s) 142 of system 100 that are transmitted to the process controller 128. The convection-section temperature data 1130 includes sensed readings from the convection temperature sensor(s) 140 of system 100 that are transmitted to the process controller 128. The stack-section temperature data 1132 includes sensed readings from the stack temperature sensor(s) 138 of system 100 that are transmitted to the process controller 128. The radiant-section pressure data 1134 includes sensed readings from the radiant pressure sensor(s) 126 of system 100 that are transmitted to the process controller 128. The convection-section pressure data 1136 includes sensed readings from the convection pressure sensor(s) 127 of system 100 that are transmitted to the process controller 128. The stack-section pressure data 1136 includes sensed readings from the stack pressure sensor(s) 129 of system 100 that are transmitted to the process controller 128. The heater data 1126 may also include data regarding other heater sensors not necessarily shown in FIG. 1, but known in the art.

In embodiments, the sensor database 130 further includes emissions data 1140. The emissions data 1140 includes O₂ reading(s) 1142, CO reading(s) 1144, and NO_{X} reading(s) 1146. The O₂ reading(s) 1142 include sensed readings from the oxygen sensor 132 transmitted to the process controller 128. The CO reading(s) 1144 include sensed readings from the carbon monoxide sensor 134 transmitted to the process controller 128. The NO_{X} reading(s) 1146 include sensed readings from the NO_{X} sensor 136 transmitted to the process controller 128. The emissions data 1140 may also include data regarding other emissions sensors not necessarily shown in FIG. 1, but known in the art.

In embodiments, the sensor database 130 includes process-side data 1170 regarding the conditions of the process tubes 106 and the process occurring. The process-side data 1170 includes process tube temperature 1172, and the outlet fluid temperature 1174. The process tube temperature 1172 may include data captured by the process tube temperature sensor 168, discussed above. The outlet fluid temperature 1174 may include data captured by an outlet fluid sensor (not shown), such as a thermocouple. The process-side data 1170 may also include data regarding other process-side sensors not necessarily shown in FIG. 1, but known in the art.

Data within the sensor database 130 is indexed according to the sensor providing said readings. Accordingly, data within the sensor database 130 may be used to provide real-time operating conditions of the system 100.

The memory 1104, in embodiments, further includes one or more of a fuel analyzer 1148, an air analyzer 1150, a draft analyzer 1152, an emissions analyzer 1154, a process-side analyzer 1176, and any combination thereof. Each of the fuel analyzer 1148, air analyzer 1150, draft analyzer 1152, emissions analyzer 1154, and process-side analyzer 1176 comprise machine readable instructions that when executed by the processor 1102 operate to perform the functionality associated with each respective analyzer discussed herein. Each of the fuel analyzer 1148, air analyzer 1150, draft analyzer 1152, emissions analyzer 1154, and process-side analyzer 1176 may be executed in serial or parallel to one another.

The fuel analyzer 1148 operates to compare the fuel data 1110 against one or more fuel alarm thresholds 1156. One common fuel alarm threshold 1156 includes fuel-pressure threshold that sets a safe operation under normal operating condition without causing nuisance shutdowns of the system 100 due to improperly functioning burner 104 caused by excess or low fuel-pressure. The fuel alarm thresholds 1156 are typically set during design of the system 100. The fuel analyzer 1148 may analyze other data within the sensor database 130 not included in the fuel data 1110, such as any one or more of air data 1118, heater data 1126, emissions data 1140, process-side data 1170, and any combination thereof to ensure there is appropriate air to fuel ratio within the heater to achieve the stoichiometric conditions for appropriate generation of the thermal energy 112.

The air analyzer 1150 operates to compare the air data 1118 against one or more air alarm thresholds 1158. One common air alarm threshold 1158 includes fan operating threshold that sets a safe operation condition of the forced fan 124 and/or stack fan 122 under normal operating condition without causing nuisance shutdowns of the system 100 due to improper draft within the heater 102 caused by excess or low air pressure throughout the system 100. The air alarm thresholds 1158 are typically set during design of the system 100. The air analyzer 1150 may analyze other data within the sensor database 130 not included in the air data 1118, such as any one or more of fuel data 1110, heater data 1126, emissions data 1140, process-side data 1170, and any combination thereof to ensure there is appropriate air to fuel ratio within the heater to achieve the stoichiometric conditions for appropriate generation of the thermal energy 112.

The draft analyzer 1152 operates to compare the heater data 1126 against one or more draft alarm thresholds 1160. One common draft alarm threshold 1160 includes heater pressure threshold that sets safe operation conditions of the heater 102 under normal operating condition without causing nuisance shutdowns or dangerous conditions of the system 100 due to positive pressure within the heater 102 (such as at the arch of the heater 102). The draft alarm thresholds 1160 are typically set during design of the system 100. The draft analyzer 1152 may analyze other data within the sensor database 130 not included in the heater data 1126, such as any one or more of fuel data 1110, air data 1118, emissions data 1140, process-side data 1170, and any combination thereof to ensure there is appropriate operating conditions within the heater 102 to achieve the stoichiometric conditions for appropriate generation of the thermal energy 112.

The emissions analyzer 1154 operates to compare the emissions data 1140 against one or more emission alarm thresholds 1162. One emissions alarm threshold 1162 include a minimum and maximum excess oxygen level that sets safe operation conditions of the heater 102 under normal operating condition without causing nuisance shutdowns or dangerous conditions of the system 100 due to too little or too much oxygen within the heater 102 during creation of the thermal energy 112. Other emission alarm thresholds 1162 include pollution limits set by environmental guidelines associated with the location in which system 100 is installed. The emission alarm thresholds 1162 are typically set during design of the system 100. The emissions analyzer 1154 may analyze other data within the sensor database 130 not included in the emissions data 1140, such as any one or more of fuel data 1110, air data 1118, heater data 1126, process-side data 1170, and any combination thereof to ensure there is appropriate operating conditions within the heater 102 to achieve the stoichiometric conditions for appropriate generation of the thermal energy 112.

The process-side analyzer 1176 operates to compare the process-side data 1170 against one or more process thresholds 1178. One common process threshold 1178 includes a desired outlet temperature to achieve efficient process conversion in the process tubes 106. Another example process threshold 1178 includes a maximum temperature threshold of the process tube 106 at which the process tube 106 is unlikely to fail. The process-side analyzer 1176 may analyze other data within the sensor database 130 not included in the process-side data 1170, such as any one or more of fuel data 1110, air-data 1118, heater data 1126, emissions data 1140, and any combination thereof to ensure there is appropriate air to fuel ratio within the heater to achieve the stoichiometric conditions for appropriate generation of the thermal energy 112.

The fuel alarm threshold 1156, common air alarm threshold 1158, draft threshold 1160, emissions threshold 1162 and process threshold 1178, and any other thresholds discussed herein may differ from system to system. They may be based on the amount of deviation from an expected value that an operator is willing to allow. The thresholds discussed herein may be set based on sensor and other hardware error tolerances. The thresholds discussed herein may be set based on regulations allowing certain tolerances for emissions or other operating conditions. The thresholds discussed herein may be set according to safety conditions for operating the heater 102.

The thresholds may also be set based on an uncertainty associated with calculated or predicted values, such as an artificial intelligence engine uncertainty. The uncertainties may be identified using the intelligent prediction engine discussed below. In such embodiments, the systems and methods herein may accommodate error ranges to provide a prediction confidence region around the output of an expected value that is then compared to sensed values to trigger one or more of the control signals 1164, alarms 1166 and/or displayed operating conditions 1168 when the sensed value deviates from the expected value past one or more of the fuel alarm threshold 1156, common air alarm threshold 1158, draft threshold 1160, emissions threshold 1162 and process threshold 1178. The sensors used to capture sensed data (e.g., the real-time sensed data and/or historical data of the system) may not be entirely accurate resulting in a sensor-based calculation uncertainty value. The sensor-based calculation uncertainty value is typically a fixed percentage that can change based on a calculated value (e.g., sensors are X % efficient when measuring temperatures across a first range, and Y % efficient across a second range). Similarly, the artificial intelligence engine may have an AI uncertainty that varies based on given inputs to the artificial intelligence engine. The AI engine, for example, models historical combined data distributions and analyzes statistical deviations of the current distribution on a scale of 0 to 100%. The predicted confidence region allows a given prediction by the physics-based calculations and/or the AI-based engine to accommodate variances in the associated data. The prediction confidence region may be calculated based on a predicted value plus or minus an uncertainty value based on one or both of the sensor-based calculation uncertainty value and/or the AI-engine uncertainty. The uncertainty value may be, for example, the sum of the sensor-based calculation uncertainty value and/or the AI-engine uncertainty. The uncertainty value may be, for example, the square root of the sensor-based calculation uncertainty, squared, plus the AI-engine uncertainty, squared. Use of an uncertainty value when comparing sensed and expected/predicted/calculated values prevents false identifications of conditions within the process heater 102 in the system. Use of a predicted confidence region based on an uncertainty value as discussed above may apply to any one or more of the “expected”, “modeled”, “predicted”, “calculated” values or the like discussed in this application.

The fuel analyzer 1148, the air analyzer 1150, the draft analyzer 1152, the emissions analyzer 1154, and the process-side analyzer 1176 operate to create one or more of control signals 1164, alarms 1166, and displayed operating conditions 1168. The control signals 1164 include signals transmitted from the process controller 128 to one or more components of the system 100, such as the dampers 118, air registers 120 (if electrically controlled), fans 122, 124, and valves 162. The alarms 1166 include audible, tactile, and visual alarms that are generated in response to tripping of one or more of the fuel alarm threshold 1156, air alarm threshold 1158, draft alarm threshold 1160, and emission alarm threshold 1162. The displayed operating conditions 1168 include information that is displayed on the display 1108 regarding the data within the sensor database 130 and the operating conditions analyzed by one or more of the fuel analyzer 1148, air analyzer 1150, draft analyzer 1152, emissions analyzer 1154, and process-side analyzer 1176.

Referring to FIG. 1, one or more of the fuel analyzer 1148, the air analyzer 1150, the draft analyzer 1152, the emissions analyzer 1154 and the process-side analyzer 1176 may be entirely or partially implemented on an external server 164. The external server 164 may receive some or all of the data within the sensor database 130 and implement specific algorithms within each of the fuel analyzer 1148, the air analyzer 1150, the draft analyzer 1152, the emissions analyzer 1154 and the process-side analyzer 1176. In response, the external server 164 may transmit one or more of the control signals 1164, the alarms 1166, and/or the displayed operating conditions 1168 back to the process controller 128.

When unwanted excess air (also referred to as tramp air) enters the heater 102, the excess oxygen level sensed by the oxygen sensor 132 increases. Air is “unwanted” in that it is not expected during control of the system—all burners are controlled to have at least some amount of excess air to drive a desired amount of excess oxygen at the stack while maintaining safe and stoichiometric conditions for combustion. Conversely, the oxygen level sensed by the oxygen sensor 132 may lower for a variety of reasons such as: additional fuel entering the system (e.g., via a leak in the process tubes 106 causing excess material to enter the heater housing 103); when a burner air register is not moving when actuated; when something—e.g., debris, insulation, etc.—is blocking the air input at one or more burners 104, ambient air inlet blocked via insects and/or birds' nests, heater insulation falling into the burner 104 throat, etc.).

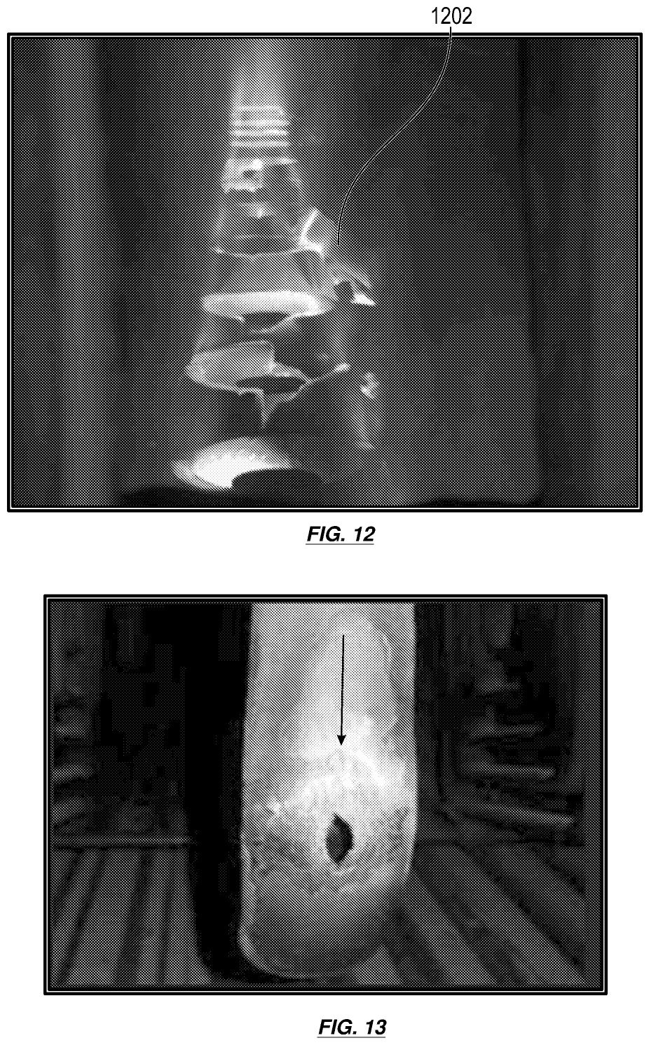

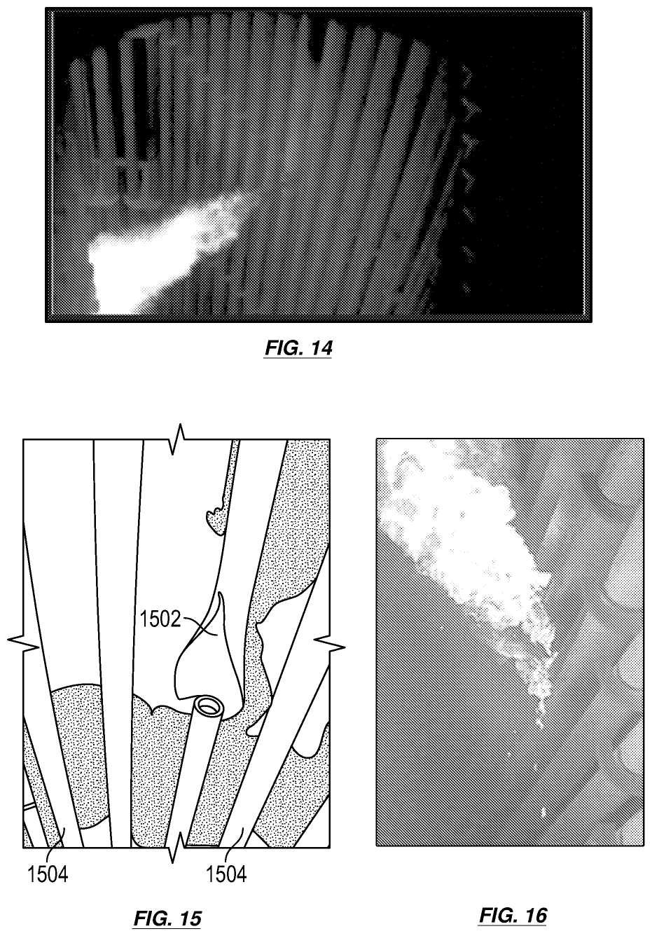

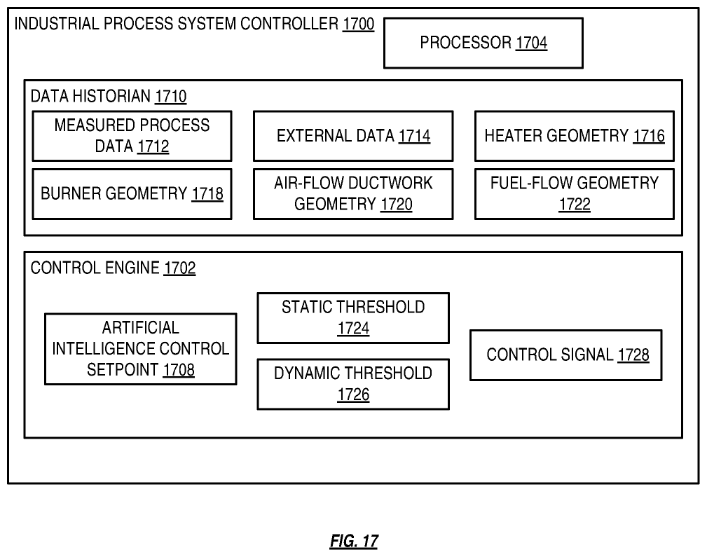

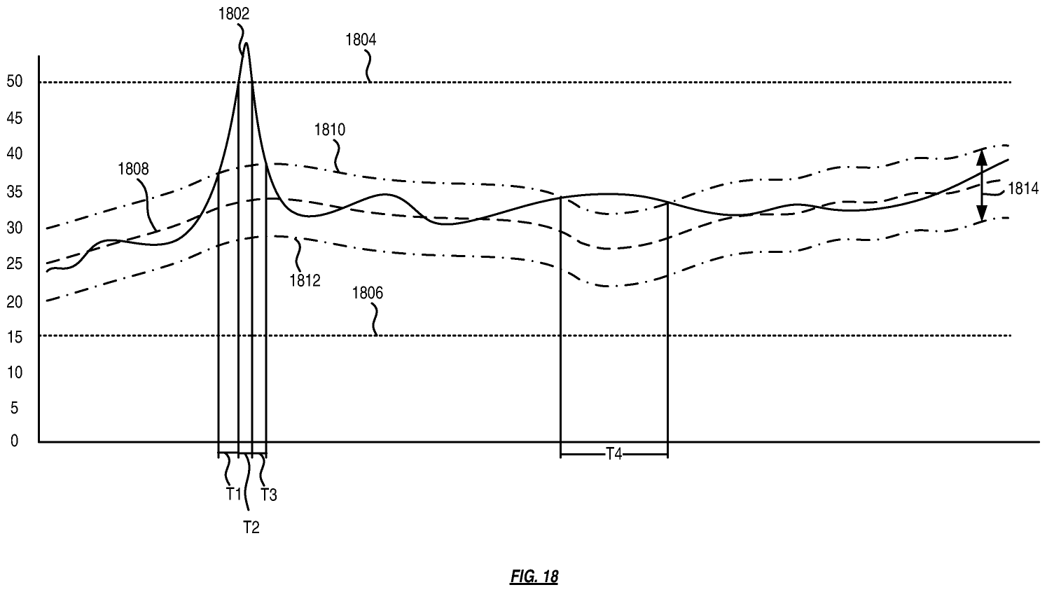

FIGS. 12-16 depict examples of various operating conditions resulting in sensed oxygen readings by the oxygen sensor 132 that cause incorrect control of the input fuel/air ratio to the burner 104. FIG. 12 shows a tile 1202 fallen from the interior of the housing and blocking air input to a burner. FIG. 13 depicts one pin-hole that causes excess fuel to enter into the system for example as shown in the infrared image of FIG. 14. FIG. 15 shows a blown-open process tube 1502 causing significant release of fuel into the system as shown in FIG. 16. The polished look 1504 of the tubes adjacent the blown-open process tube 1502 in Figure indicates flame impingement causing inefficient or improper heating conditions within the process tube, which was likely the cause of the tube failure.

Significant excess, or insufficient, air within the heater 102 causes an unbalanced stoichiometric condition for generating the thermal energy 112, thereby resulting in unfavorable (and often unsafe) operating conditions. Typically, the oxygen sensor output is trusted by operations personnel to be the primary indication that there is sufficient and proper air for combustion to occur safely. Currently, there are limited options for ensuring that the measured excess oxygen in the system is coming through the burners as designed. Visual analysis by a human operator is frequently required to check for conditions in the heater that may indicate excess or insufficient air. When there is excess tramp air in the system, if the operator is unaware and controlling based on the sensed oxygen levels by the oxygen sensor 132, the operator and/or heater controller 128, often reduces the input air to the burner because the global oxygen sensor 132 indicates there is too much air. Thus, the flames (e.g., thermal energy 112) from the burner 104 may extend too far from the burner 104 because the oxygen in the excess tramp air is being used to burn the extra fuel (because the controlled input fuel/air ratio is too high). These extended flames cause the process tubes 106 in the system to heat improperly resulting in inefficient or dangerous operation. Blocked input air in the system (see FIG. 12), or excess fuel in the system (see FIGS. 13-16) causes the operator or control system to increase the air flow through the burners, in attempts to raise the measured excess O2. In doing so, the burner air fuel ratio will be unintentionally driven to a fuel lean condition (more excess air going through the burners than is being measured), which can result in unstable burners which is also dangerous and/or an inefficient condition.

The above embodiments illustrate an industrial process system in the form of a combustion system. However, it should be appreciated that the algorithms and control schema discussed herein apply to other types of industrial processes and associated industrial process equipment. For example, the control engines, algorithms, functions, hardware, etc. discussed herein can apply to control and analyze one or more of: petrol systems, coal processing systems, chemical processing systems, plastic processing systems, mineral processing systems, primary metal processing systems, fabricated metal processing systems, food and/or beverage processing systems, textile processing systems, wood processing systems, paper processing systems, printing systems, computer and electronics processing systems, electrical equipment processing systems, appliance systems, transportation manufacturing processing systems, pharmaceutical processing systems, and other types of industrial process systems and equipment related to the same.

Accordingly, it should be understood that, although embodiments herein refer to a heater 102 with various sensors disbursed throughout, and heater controller 128 having a sensor database 130, similar components may be implemented in other types of industrial process systems, such as those discussed above. Accordingly, the disclosure herein is not limited solely to combustion systems, but to other types of industrial process systems having sensors that collect data that is stored within a sensor database (e.g. sensor database 130), and utilized by a controller (e.g., heater controller 128) to implement automated, or semi-automated, control of the system being monitored by the sensors.

### Artificial Intelligence-Based Control:

In feed-forward control systems, such as those industrial process systems discussed above, upstream measurements are used to explicitly control a process output. An example case is the use for fuel- and air-flow measurements in a combustion system to produce a control scheme that can maintain a desired excess air level without relying on an out of stack measurement. One of the benefits behind feed-forward control is the reduced dependency on a process output parameter (such as out of the stack O₂) that is delayed. Although the O₂ out of the stack is constantly measured, it is placed far downstream the combustion and it requires a flue gas sample to reach an analyzer that is placed a considerable distance away from the stack. By the time a global O₂ measurement is reported to the control system, minutes have elapsed, and the measurement may not be representative of the current state of the combustion process taking place within the heater. Implementing a successful control system that uses controlling variables with such delay can be difficult specially when the burner stability is sensitive to the air/fuel ratio (excess O₂) available. Furthermore, while there is a strong relationship between air/fuel ratio and excess O₂, there are other variables that can affect that relationship (e.g. fuel composition, air quality, completeness of combustion, etc.). The impact of these variables is often mitigated by implementing corrections in control blocks within the control system. While these are helpful, they increase complexity of the control scheme and their impact on the control system can be difficult to evaluate holistically as these corrections may be implemented in different function blocks.

Feed-forward control systems can also be implemented to control process outputs of great interest (such as NOx emissions) through implicit relationships. NOx emissions are a regulated pollutant affected by many variables that range from fuel and air composition, to the geometry of the combustion equipment. Therefore, establishing a feed-forward control strategy focused on a target NOx emission (or any other emissions) results in a rather complex, hard to maintain and difficult to evaluate control system. With the proliferation of machine learning (ML) and artificial intelligence (AI), a novel industry practice may leverage ML model(s) to recommend a control setpoint used in a feed-forward control scheme, where, for example, the desired target NOx emission is an input. These types of control systems are often referred to as Advanced Process Control (APC) or Model Process Control (MPC) systems.

Relinquishing control to a ML/AI control scheme of industrial process systems provides many challenges, however. While leveraging ML setpoint recommendations (or control outputs) can result in successful control, these recommendations are often regarded as a “black box” of sorts. Therefore, the safety boundaries that are put in place, in addition to being static, may be too narrow (to prevent the system from reaching an unsafe state) or too wide (to reduce the number of nuisance trips). Unfortunately, either approach taken may inadvertently result on a compromise of the equipment's safety and/or reliability.

Safety is of upmost importance, as any failure of control of the industrial process could result in an environmental, health, or safety incident. Further, such control must adhere to environmental regulations (such as emissions regulations for combustion systems) and other regulations where, control of one part of the system may have downstream implications. Typically, such safety and regulatory adherence is achieved via electronic and mechanical safeguards, and subject matter expertise of the industrial process system operator. However, as more control is implemented via ML and AI algorithms, although the ML and AI algorithms implement such subject matter expertise, the operator is potentially taken out of the processes because the human operator is not implementing the control schemes, unless required to do so before any automatic control is implemented. However, approval of all automatic control signals by a human operator is inefficient and unrealistic.

Applying appropriate dynamic boundaries to ML/AI setpoint(s) recommendation(s) implemented in feed-forward control schemes, can significantly benefit the safety and reliability of a control system and, in many cases, mitigate instrumentation complexity and costs. ML/AI recommendation provides the benefit of desirable recommendation accuracies especially where a substantial number of variables are involved. In addition, these models can be set in such manner where they constantly improve with the addition of new data. Thus, the ML/AI setpoint makes the field application much more desirable as it includes dynamic field conditions into the recommendation. However, ML/AI models rely on quality training data to make satisfactory recommendations. Therefore, when the model faces operating conditions outside the training data, ML/AI models are likely to fail at making an accurate recommendation. On the other hand, First Principle (FP) based recommendations (e.g. recommendations that use Newtonian mechanics and thermodynamic principles) are much less sensitive to inaccuracy when facing uncharted operating conditions, but do not offer the recommendation accuracy or speed often found in ML models. The present embodiments realize a control approach that exclusively leverages both, the evolving/sustained precision of ML model and safety of FP models, gives way to a more effective implementation of feed-forward control systems.

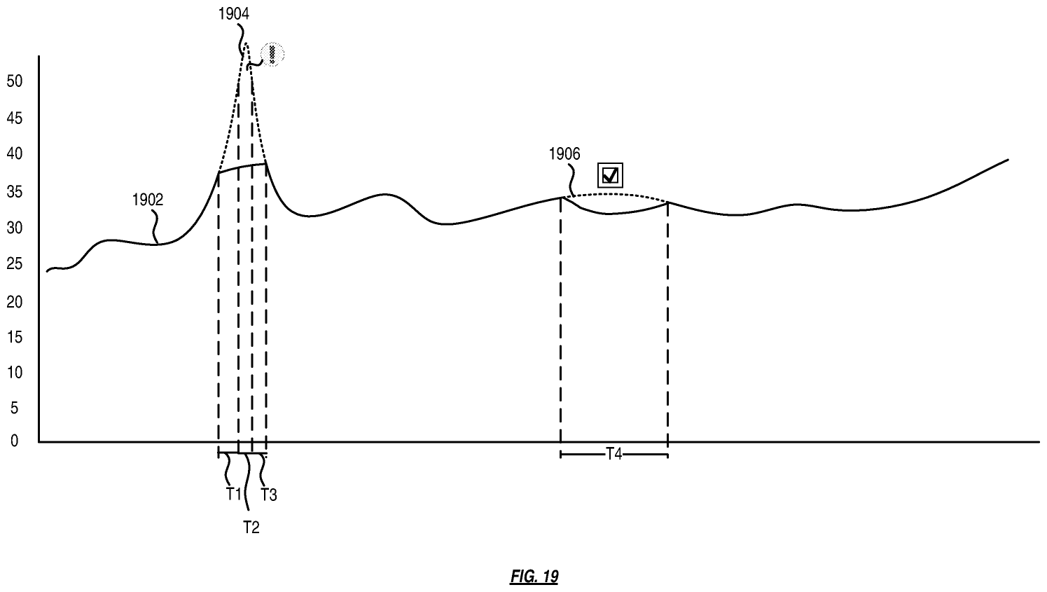

FIG. 17 depicts an industrial process system controller 1700, including a control engine 1702 that is executable by a processor 1704 to generate a control signal 1728 for use in a feed-forward control system, in embodiments. Industrial process system controller 1700 may be an example of any one or more of fuel analyzer 1148, air analyzer 1150, draft analyzer 1152, emissions analyzer 1154, and/or process-side analyzer 1176, or another analyzer utilized in other non-combustion system types of industrial processes.

Industrial process system controller 1700 may be implemented on-site at the industrial process (e.g., as a component of heater controller 128), or on the “cloud” at an external server (e.g., external server 164) where data is transmitted from the industrial process system (e.g., from sensor database 130) to the external server 164 and outputs from the industrial process system controller 1700 located at the external server 164 are transmitted back to the industrial process system (e.g., to heater controller 128) for implementation thereby. Moreover, any one or more elements shown in industrial process system controller 1700 may be distributed among on-site and off-site components, such as distributed between the heater controller 128 and the external server 164. Moreover, the external server 164 may represent entirely, or include as a component thereof, an “edge device” that resides on-site within the firewall of the industrial process system. For example, the edge-device may reside in an “industrial demilitarized zone” (“industrial DMZ”; such as that shown in the Purdue model for Industrial control), where the edge device has controlled access to one or more security level zones below (e.g., access to the sensor database 130) and above the DMZ (e.g., access to external internet connections) at intermittent, pre-defined, and controlled periods. Moreover, the edge device may communicate with other devices, such as a data historian (e.g., a PI historian) that has different security access levels than the edge-device. This edge-device configuration accommodates varying levels of IT security to prevent undesired direct access into the heater controller 128 by the edge-device, or the external server 164.

The control engine 1702 receives an artificial intelligence control setpoint 1708. In one embodiment, the artificial intelligence control setpoint 1708 is generated off-site, using a cloud-computing host to access more efficient and powerful computing modules. In other embodiments, the artificial intelligence control setpoint 1708 is generated on-site, such as using a machine learning and/or artificial intelligence algorithm that is loaded to an edge device as discussed above, or heater controller 128 located on-site (e.g., at the same premises of the heater 102).

The artificial intelligence control setpoint 1708 may be based on a variety of data signatures found within data stored in a data historian 1710. The artificial intelligence control setpoint 1708 may include a recommendation for a process control setpoint. In embodiments where the industrial process is a combustion system such as that shown in FIGS. 1-16 above, examples of the artificial intelligence control setpoint 1708 include, but are not limited to, air-to-fuel ratio, air-flow set point, duct pressure set point, burner dP setpoint, fuel flow set point, fuel split set point, individual AIRmix/COOLmix fuel set points, and the like. The artificial intelligence control setpoint 1708 is based on a supervised or unsupervised machine learning algorithm that analyzes the multitude of data within the data historian 1710 to identify conditions within the heater (or other industrial process equipment being monitored by the industrial process system controller 1700), and output the artificial intelligence control setpoint 1708 to control the heater to a specific operating condition.

The data historian 1710 includes time-series data associated with the operation of the industrial process system. The data within the data historian 1710 may be located on-site, off-site, or distributed across multiple sources such as some security-sensitive data stored on-site, and some general data (e.g., weather-related, etc.) stored or gathered from off-site sources. The data historian 1710 includes, but is not limited to, one or more of measured process data 1712, external data 1714, heater geometry 1716, burner geometry 1718, air-flow ductwork geometry 1720, fuel-flow geometry 1722, and any combination thereof. Other types of industrial process systems may utilize other types of measured and external data specific to the given industrial process application as will be known to those of ordinary skill in the art. The measured process data 1712 may include any of the data sensed by any sensor at and/or within the industrial process system (e.g., heater 102), including any of the data within sensor database 130, described above. The industrial process system controller 1700 may further receive, and store in the data historian 1710, external data 1714, which may include weather information about ambient conditions surrounding the industrial process system. The industrial process system controller 1700 may further receive, and store in the data historian 1710, one or more of heater-specific data, which may include heater geometry 1716 (e.g., shape, size of the heater 102), burner geometry 1718 (e.g., shape, size, number of burners, burner configurations, burner locations, etc.), air-flow ductwork geometry 1720 (e.g., number of air inlets/outlets, shape, size, etc.), fuel-flow geometry 1722 (e.g., number of fuel inlets/outlets, valve configurations, shape, size, etc.), and any other information externally-sourced used to calculate operating parameters of the industrial process system. The measured process data 1712, and external data 1714, and heater geometry data 1716 may be time-series data including historical values of given data points. The burner geometry 1718, air-flow ductwork geometry 1720, and fuel-flow geometry 1722 is likely static data because these are unlikely to change. However, if any of the burner geometry 1718, air-flow ductwork geometry 1720, and fuel-flow geometry 1722 is changeable (e.g., via changing of air-flow valves or fuel-flow valves, or changing of the burner geometry), then such historical changes will also be stored in the associated data.

As discussed above, there is trepidation by operators in relying on just the artificial intelligence control setpoint 1708 to control the industrial process (e.g., heater 102) because were the artificial intelligence control setpoint 1708 to automatically control to an unsafe position, there would be potential of an environmental, health or safety incident. The control engine 1702 eases this trepidation by determining a static threshold 1724 and a dynamic threshold 1726 to set guiderails on the artificial intelligence control setpoint 1708 and produce a control signal 1728 that ensures the incoming artificial intelligence control setpoint 1708 is not going to steer the industrial process (e.g., heater 102) into an unsafe condition. The control signal 1728 may be implemented by the control engine 1702, or may be transmitted to another device, such as heater controller 128 for implementation thereby.

The static threshold 1724 (also referred to as a static clamp) includes an upper and lower boundary that, when breached by the artificial intelligence control setpoint 1708, indicates a clear error (e.g., missing data, broken sensor, etc.) within the control engine 1702 that caused the ML/AI algorithm to produce the artificial intelligence control setpoint 1708 that will result in an unsafe condition because the setpoint is outside of a mechanical, hardware, or operating safety limit of the components of the industrial process (e.g., heater 102). An example of a static threshold 1724 in regard to a combustion system includes an air/fuel ratio are the upper and lower bounds of a safe operating condition, for a given fuel composition (or a plurality of different fuel compositions). Thus, the static threshold 1724 is based on hardware limits for the variety of components of the industrial process system (e.g., heater 102) that relate to the given artificial intelligence control setpoint 1708.

The dynamic threshold 1726 includes an upper and lower boundary that bound the artificial intelligence control setpoint 1708 according to an additional calculation of the setpoint different than the ML/AI control algorithm. These setpoints in feed-forward controls would be calculated based on one or more of First Principle calculations, Subject-Matter-Expertise (SME) statistical calculations, advanced simulations (e.g., computational fluid dynamics (CFD), Finite Element Analysis (FEA), etc.), or combinations thereof. Operators are comfortable with these control schemes because they have been used in the field for a long time. The control engine 1702 of the present embodiments utilizes the calculation uncertainty of the First Principle calculations, SME statistical calculations, advanced simulations (e.g., CFD, FEA, etc.), and combinations thereof to set an upper and lower bounds of the dynamic threshold 1726. Therefore, the control engine 1702 benefits from both types of calculations at the same time.

In some embodiments, the control engine 1702 generates the dynamic threshold 1726 based on First Principle analysis. For example, the control engine 1702 leverages physics-based equations to produce recommendation(s) of the desired control variable that corresponds to the artificial intelligence control setpoint 1708. To determine the dynamic threshold 1726 based on First Principle analysis, the control engine 1702 may obtain the necessary variables from the data historian 1710 and apply physics calculations to such data to determine a desired control setpoint corresponding to the artificial intelligence control setpoint 1708. Since the boundaries generated using this First Principle analysis are well informed of the physics/thermodynamic phenomena taking place, these models are likely to successfully extrapolate when operations shift to a less common operation state. The advantage of this method is primarily around the increased safety of operation as it will effectively mitigate possible ML recommendation inaccuracies resulting from uncharted operating conditions.

In some embodiments, the control engine 1702 generates the dynamic threshold 1726 based on SME statistical boundary generation. In these embodiments, the SME understanding of what operational inputs significantly impact the process output is used in conjunction with a statistical regression (e.g. Multiple Variable Regression) to make a recommendation of the target variable that corresponds to the artificial intelligence control setpoint 1708. The SME statistical analysis also has calculation uncertainties associated therewith. Thus, the dynamic threshold 1726 in these embodiments includes the upper and lower bounds of the statistical calculation uncertainty (e.g., the statistical calculation value, that corresponds to the artificial intelligence control setpoint 1708, plus and minus the statistical calculation uncertainty). Unlike a first principles physics-based boundary, this allows for a reduced number of variables needed for an appropriate recommendation. In addition, the regression can be engineered into a function that has a much lower computing power demand making it prime for DCS implementation on-site at the heater controller 128, or at an edge-device configuration, where the computational power and speed is more limited. Like the First-Principle physics based boundary generation embodiments, statistical models are not as susceptible to unseen operating conditions as ML/AL models are.

In some embodiments, the control engine 1702 generates the dynamic threshold 1726 based on an advanced simulation boundary generation. Advanced simulation boundary generation is a comprehensive version of the FP principle method where simulations processes such as Computational Fluid Dynamics (CFD) or Finite Element Analysis (FEA) are used to generate boundaries with tighter tolerances. These simulations can produce insights with greater resolution that can be used as input data information. The additional information can provide the insights that not only reduce the number of measurements needed for recommendation, but also enhance the quality of the recommendation by introducing measurements that cannot be practically measured in the field (e.g. Adiabatic Flame Temperature, Flue gas entrainment, local temperatures, etc.). Thus, the dynamic threshold 1726 in these embodiments includes the upper and lower bounds of the uncertainty associated with the advanced simulation (e.g., the solved value of the advanced simulation, that corresponds to the artificial intelligence control setpoint 1708, plus and minus the calculation uncertainty of the advanced simulation). There is a significant demand in terms of computing power, making this approach suitable for control processes that change with a lower frequency.

In some embodiments, the control engine 1702 generates the dynamic threshold 1726 based on a hybrid approach of multiple types of calculations. These embodiments combine capability from the embodiments above to mitigate the downfalls of each of the type of dynamic threshold generation mentioned above. For example, the reduction of number of measurements implemented in the field is desirable from a cost efficiency perspective. As mentioned before this can be done by leveraging a statistical (MVR or ML) model for the recommendation of a target variable corresponding to the artificial intelligence control setpoint 1708. It can also be done by making, deriving, or predicting an input variable (therefore avoid having to implement the measurement), as discussed below.

Traditional measurements can be replaced by calculations derived from the interaction/observations within the process system. Air measurement for a process heater is a good example of such case. Combustion air flow can be measured by using a traditional measurement device such as an annubar or an anemometer. However, the pressure drop across a process burner can also be used to calculate the airflow using FP based calculations eliminating the need of the actual airflow measurement.

Input data information generated through supplemental information provided by measuring devices is often referred to “inferential sensing.” This approach seeks to combine the information of multiple measurements to infer a target measurement. As example in a combustion burner, the flame strength of a scanner can be used in conjunction with other measurements, to infer the current AFR of the combustion which a paramount input variable to the recommendation of NOx emissions.

Another example of a hybrid approach uses both hardware uncertainty and historical uncertainty associated with the calculations used to determine the target control setpoint corresponding to the artificial intelligence control setpoint 1708. The hardware uncertainty value may be a fixed value (e.g., a value that does not change over time for each set of variables used to determine the target control setpoint corresponding to the artificial intelligence control setpoint 1708) and is based on the instrument measurement uncertainty for each sensor that obtains a piece of data used to calculate the target control setpoint corresponding to the artificial intelligence control setpoint 1708. The hardware uncertainty value acknowledges that every measurement has some uncertainty associated with it. Thus, the hardware uncertainty value propagates the uncertainty (which may be defined in the technical data sheet of a given measurement device, or calculated on-field) associated with all calculations necessary to determine the predicted operating parameter.

In some embodiments, the hardware uncertainty value is propagated according to the law of propagation of uncertainties, and assuming all constituent variables of an equation are independent. In other words, the covariance of all combinations of constituent variables is zero. For example, given a calculated predicted operating parameter (Y) that is a function of several variables as shown in equation 1, below, and the associated uncertainties of the individual variables: ωₓ₁, ωₓ₂, ωₓ₃, . . . , ω_{xN}.

Y=ƒ(x₁,x₂,x₃, . . . ,x_{N}) Eq. 1

The uncertainty of Y is calculated using equation 2, below:

$${ω}_{Y} = \sqrt{{\sum }_{i = 1}^{N} {( {ω}_{{x}_{i}} \frac{\partial f}{\partial {x}_{i}} )}^{2}} \qquad Eq . 2$$

The uncertainties for the calculated quantities utilize the base measurement uncertainties. The uncertainties for a given sensor may be default based on the technical datasheet associated with that sensor, or the default uncertainty may be overwritten based on actual measurement uncertainties with appropriate attributes given.

The historical uncertainty may be based on an artificial intelligence-based analysis of historical combined data distribution defining how far away has the current distribution shifted from the historical data in the data historian 1710. The historical uncertainty may be on a scale of 0 to 100%. To generate the historical uncertainty, the control engine 1702 may model a statistical deviation of each variable (e.g., measurement) used to calculate the target control setpoint corresponding to the artificial intelligence control setpoint 1708. These statistical deviations may then be fused into a multi-dimension space distribution.

The model of statistical deviation of each measurement may be based on a Gaussian Mixture Model (GMM), to ensure distribution objectively represents the actual distribution of the input variable in the target control setpoint corresponding to the artificial intelligence control setpoint 1708, instead of either considering everything to be Gaussian distributed or incorrectly assuming that the distribution is a fixed format such as Rayleigh or Poisson distribution etc.

Using GMM, the control engine 1702 accurately describes the distributions for each variable used in target control setpoint corresponding to the artificial intelligence control setpoint 1708, as well as finds the cluster centroid for all the input variables combined.

Using the GMM model, the control engine 1702 identifies the historical uncertainty that describes how much drift is present, for each incoming input variable (or set of variables) used to calculate target control setpoint corresponding to the artificial intelligence control setpoint 1708, as compared to the historical norm for that variable (or collection of variables) by a scale from 0 to 100%. This provides an advantage of a systematic and wholistic view of the historical data in the data historian 1705, where 100% “drift” indicates a complete drift with a given Probability of False Alarm (PFA).

In embodiments, the hardware uncertainty, and the historical uncertainty may be calculated each time a data entry comes into the data historian 1710. In embodiments, each of the hardware uncertainty and the historical uncertainty is calculated each time the target control setpoint corresponding to the artificial intelligence control setpoint 1708 is calculated.

The control engine uses the hardware uncertainty and the historical uncertainty to generate a recommendation confidence region for the target control setpoint corresponding to the artificial intelligence control setpoint 1708. The boundary of the recommendation confidence region is then used as the upper and lower bounds of the dynamic threshold 1726. This recommendation confidence region results in fewer false-positive identifications of potentially unstable conditions in the combustion system.

In an embodiment, the recommendation confidence region is defined as P±\sqrt{U_{HW}²+U_{Hist}²}; where P is the value of the target control setpoint corresponding to the artificial intelligence control setpoint 1708; U_{HW} is the hardware uncertainty that includes uncertainties for each variable propagated throughout the calculations necessary to generate the target control setpoint corresponding to the artificial intelligence control setpoint 1708; and U_{Hist} is the historical uncertainty that defines how far away has the current distribution shifted from the historical data in the data historian 1710. In an embodiment, the recommendation confidence region is defined as P±(U_{HW}+U_{Hist}).

Table 1, below, depicts various considerations that would be analyzed based on the particular application to determine how the dynamic threshold 1726 is determined.

TABLE 1

| | | | Advanced | |
|---|---|---|---|---|
| Method | FP method | Statistical | Simulation | Hybrid |
| Frequency | Medium - | High - | Low - Simulation | Variable - |
| demand | Calculation can | Calculation are a | can take hours to | Depending on |
| | take minutes to | close form | converge | methods |
| | converge | solution that | depending on | combination used |
| | | takes seconds to | available | |
| | | resolve even with | computation | |
| | | low computing | power | |
| | | power | | |
| Quantity of field | Medium/High - | Low - When | High - Complete | Variable - |
| measurements | Complete | critical variables | description of the | Depending on |
| required/data | description of the | are available | environment is | methods |
| inputs | environment is | High - When | needed for the | combination used |
| | needed for the | critical variables | recommendation | |
| | recommendation | are not available | | |
| Accuracy of | Medium - | High - Within | High - For | Variable - |
| recommendation | Typically +−10- | data set used for | accurately | Depending on |
| | 20% at all times | the model | defined models | methods |
| | | development | and boundary | combination used |
| | | Low - Outside of | conditions | |
| | | data set used for | | |
| | | the model | | |
| | | development | | |

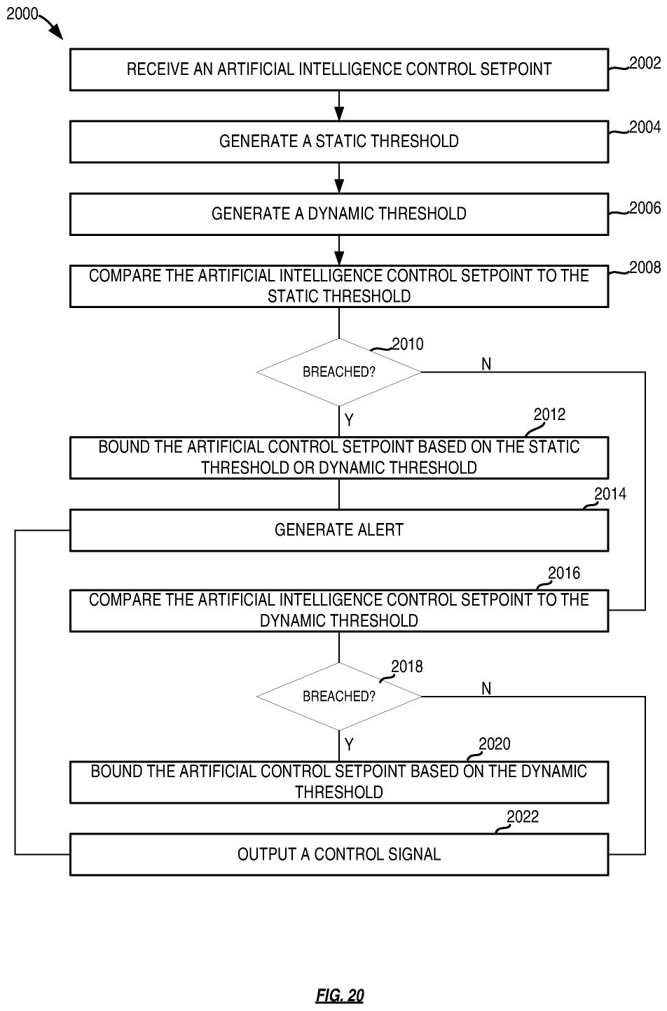

FIG. 18 shows an example comparison made by the control engine 1702 of the artificial intelligence control setpoint 1708, to the static threshold 1724 and the dynamic threshold 1726 to generate the control signal 1728. FIG. 19 shows an example of the output control signal 1900 based on the data of FIG. 18. FIGS. 18 and 19 are best viewed together with the following description.

In FIG. 18, line 1802 is an example of the artificial intelligence control setpoint 1708. Line 1804 is an example of the upper bound of the static threshold 1724. Line 1806 is an example of the lower bound of the static threshold 1724. Line 1808 is the calculated value of the dynamic threshold 1726 that corresponds to the artificial intelligence control setpoint 1708. Upper bound line 1810 is an example of the upper bound of the dynamic threshold 1726. Line 1812 is an example of the lower bound of the dynamic threshold 1726. Thus, range 1814 is the uncertainty region of the calculated value that corresponds to the artificial intelligence control setpoint 1708. The uncertainty region may be based on a consistent value above/below the calculated value (i.e. ±5 from the calculated value), or a percentage above/below the calculated value.

As shown, during time periods T1, T3, and T4 the artificial intelligence control setpoint line 1802 is above the upper bound line 1810 of the dynamic threshold and below the upper bound 1804 of the static threshold. During time period T2, the artificial intelligence control setpoint line 1802 is above both the upper bound line 1810 of the dynamic threshold and below the upper bound 1804 of the static threshold.

Based on the data of FIG. 18, the control engine 1702 would generate a control signal 1728 corresponding to line 1902 in FIG. 19. To create the control signal of line 1902, the control engine 1702 may bound the artificial intelligence control setpoint 1708 according to the static threshold 1724 and/or the dynamic threshold 1726. In the embodiment of FIGS. 18 and 19, the artificial intelligence control setpoint 1802 is bounded to the upper threshold in each of times T1, T2, T3, and T4. Furthermore, the control signal output may also include an alert when such bounding occurs. For example, the alert, as indicated by line segment 1906, for bounding of time T4 includes a “checkmark” or indication of approved bounding because the artificial intelligence control setpoint 1802 did not breach the upper bound 1804 or the lower bound 1806 of the static threshold.

However, at time T2, the output control includes an alert, as indicated by line segment 1904, (shown by the exclamation point in FIG. 19) that indicates something was wrong at time T2. This alert in the control signal 1728 may be an indicator that is displayed, sounded, physically present, or otherwise notified to the operator, or may cause an automatic change in operation of the heater controller 128. For example, breach of the static threshold 1724 may be caused by failure of a device providing data to the data historian 1710. If the failed device still records a value, however, and that value is sufficiently incorrect (e.g., 0, or 999999, or some null value), the machine learning algorithm that produces the artificial intelligence control setpoint 1708 may not readily know that said value is an improper value. Thus, the static threshold 1724 allows the system to identify when something is wrong in the data historian 1710. The alert in the control signal 1728 may include an identification of the sensors that provided the data from the data historian 1710 used to generate the artificial intelligence control setpoint 1708 (or the static threshold 1724).

Using the static threshold 1724 and dynamic threshold 1726 discussed in the above systems and the below methods, the control engine 1702 is able to obtain the typically more accurate setpoint of ML/AI algorithms via the artificial intelligence control setpoint 1708, and still provide the historical confidence in an automatic controller via the static threshold 1724 and dynamic threshold 1726. Such historical confidence is necessary particularly where ML/AI algorithms are trained using specific known conditions, and the ML/AI algorithms may be less accurate when they are operating on data that is sufficiently different than those known conditions.

Table 2, below, depicts a logic chart of the control engine 1702. Table 2 is shown including an “edge response” and a “DCS response.” The edge is an example of the above-discussed distributed control scheme where the artificial intelligence control set point is received or generated by an edge computer, which is then transmitted to the heater controller (e.g., a DCS controller). The heater controller then executes the associated command. In Table 2, AISCP is artificial intelligence control setpoint 1708; STUB is the upper bound of the static threshold 1724; STLB is the lower bound of the static threshold 1724; DTUB is the upper bound of the dynamic threshold 1726; DTLB is the lower bound of the dynamic threshold 1726; and CS is the control signal 1728.

TABLE 2

| Condition | Edge Response | DCS Command |
|---|---|---|
| AICSP > STUB | Transmit STUB | Command STUB plus |
| | | alert for irregular data; |
| | | possibly implement |
| | | control mode change. |
| AICSP < STUB | Transmit STLB | Command STLB plus |
| | | alert for irregular data; |
| | | possibly implement |
| | | control mode change. |
| STUB > AICSP > STLB | Transmit STUB | Command AICSP. |
| AICSP > DTUB | Transmit DTUB | Command DTUB plus |
| | | indication of for bounded |
| | | control. |
| AICSP < DTLB | Transmit DTLB | Command DTLB plus |
| | | indication of for bounded |
| | | control. |
| DTUB > AICSP > DTLB | Transmit AICSP | Command AICSP. |

As noted in the table above, in some embodiments, where the artificial intelligence control setpoint 1708 is outside of the static threshold 1724, the control signal 1728 may change the control mode of the heater controller 128 to one or both of shut down the system, and stop using automatic control based on ML and/or AI. Change of control mode is potentially necessary because something is incorrect in the data historian and the ML and/or AI model is not equipped to handle this discrepancy (e.g., it is not trained on data sufficiently correlating to the event causing the incorrect data in the data historian).

FIG. 20 shows a method 2000 for automated control of a combustion system, in embodiments. Method 2000 is implemented using the system described above with respect to FIGS. 1-19, including the industrial process system 1700 and/or the control engine 1702 described with respect to FIG. 17. Method 2000 may be implemented on-site of the combustion system, such as within the heater controller 128 or an on-site located edge device. In embodiments, method 2000 may be implemented off-site, such as at an external server, where data is transferred to the external server form an on-site data historian, the external server analyzes such data and transmits a control signal back to the heater controller for implementation thereby. In embodiments, some aspects of method 2000 are performed off-site, and some aspects of method 2000 are performed on-site. The logic implemented in method 2000 may be defined by the logic in Table 2, above.

In block 2002, the method 2000 receives an artificial intelligence control setpoint. In one example of block 2002, the control engine 1702 receives the artificial intelligence control setpoint 1708. In some embodiments of block 2002, “receive” in block 2002 may include receiving the artificial intelligence control setpoint from another device, such as heater controller 128 receiving the artificial intelligence control setpoint 1708 from external server 164.

In block 2004, the method 2000 generates a static threshold. In one example of block 2004, the control engine 1702 generates the static threshold 1724 corresponding to the artificial intelligence control setpoint 1708. Block 2004 may be implemented each time an artificial intelligence control setpoint is received, or may be implemented previously such that a variety of static thresholds are known to the control engine 1702 and selected each time an artificial intelligence control setpoint is received in block 2002.

In block 2006, the method 2000 generates a dynamic threshold. In one example of block 2006, the control engine 1702 generates the static threshold 1724 corresponding to the artificial intelligence control setpoint 1708. Block 2006 may be implemented each time an artificial intelligence control setpoint is received, or may be implemented previously such that a variety of static thresholds are known to the control engine 1702 and selected each time an artificial intelligence control setpoint is received in block 2002.

In block 2008, the method 2000 compares the artificial intelligence control setpoint to the static threshold. In one example of block 2008, the control engine 1702 compares the artificial intelligence control setpoint 1708 to the static threshold 1724.

In decision block 2010, the method 2000 determines if the artificial intelligence control setpoint breaches the static threshold. In one example of block 2010, breaching may include the artificial intelligence control setpoint being a value larger or smaller than the static threshold. If so, the method 2000 proceeds to block 2012; otherwise method 2000 proceeds to block 2016.

In block 2012, the method 2000 bounds the artificial intelligence control setpoint based on the static threshold or the dynamic threshold. In one example of block 2012, the control engine 1702 bounds the artificial intelligence control setpoint 1708 based on the static threshold 1724 or dynamic threshold 1726. In a detailed example shown in FIG. 18-19, the artificial intelligence control setpoint 1802 is bound to the upper bound 1810 of the dynamic threshold at times T1-T4 because the upper bound of the dynamic threshold is below the upper bound of the upper bound of the static threshold.

In block 2014, the method 2000 generates an alert. In one example of block 2014, the control engine 1702 generates an alert that indicates an inconsistency in the data historian 1710. If available, the alert generated in block 2014 may identify a specific sensor, or group of sensors, that correlate to the inconsistent or missing data in the data historian 1710 that causes the artificial learning control setpoint to breach the static threshold. The alert from block 2014 may be included in the control signal discussed below with respect to block 2022.

In block 2016, the method 2000 compares the artificial intelligence control setpoint to the dynamic threshold. In one example of block 2016, the control engine 1702 compares the artificial intelligence control setpoint 1708 to the dynamic threshold 1726.

Block 2018 is a decision. In block 2018, the method 2000 determines if the artificial intelligence control setpoint breaches the dynamic threshold. If so, the method 2000 proceeds to block 2020, else method 2000 proceeds to block 2022.

In block 2020, the method 2000 bounds the artificial control setpoint based on the dynamic threshold. In one example of block 2020, the control engine 1702 bounds the artificial intelligence control setpoint 1708 based on the dynamic threshold 1726. In a detailed example shown in FIG. 18-19, the artificial intelligence control setpoint 1802 is bound to the upper bound 1810 of the dynamic threshold at times T4 because the artificial intelligence control setpoint 1802 is between the upper bound of the dynamic threshold and the upper bound of the upper bound of the static threshold.

In block 2022, the method outputs a control signal. In one example of block 2022, the control engine 1702 outputs a control signal 1728 to manipulate an operating parameter of the combustion system. The control signal 1728 may include the alert generated in block 2014. In embodiments, if the control signal includes an alert, the control signal may change the control mode of the heater controller to one or both of shut down the system, and stop using automatic control based on ML and/or AI.

### Definitions

The disclosure herein may reference “physics-based models,” “First Principles” and transforming, interpolating, or otherwise calculating certain data from other data inputs. Those of ordinary skill in the art should understand what physics-based models incorporate, and the calculations necessary to implement said transforming, interpolating, or otherwise calculating for a given situation. However, at least with respect to combustion system type industrial process systems, the present disclosure incorporates by reference chapter 9 of the “John Zink Hamworthy Combustion Handbook”, which is incorporated by reference in its entirety (Baukal, Charles E. The John Zink Hamworthy Combustion Handbook. Fundamentals. 2nd ed., vol. 1 of 3, CRC Press, 2013) for further disclosure related to understanding of fluid dynamics physics-based modeling and other calculations. It should be appreciated, however, that “physics-based models” and transforming, interpolating, or otherwise calculating certain data from other data inputs is not limited to just those fluid dynamics calculations listed in chapter 9 of the John Zink Hamworthy Combustion Handbook.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween. Examples of combination of features are as follows:

### Combination of Features:

The above described features may be combined in any manner without departing from the scope hereof. The below combination of features includes examples of such combinations, where any feature described above may also be combined with any embodiment of the aspects described below.

In an embodiment (A1) of a first aspect, a system for automated control of an industrial process system includes: a data historian storing measured process data sensed by a plurality of sensors within the industrial process system; a processor; and, memory storing a control engine as computer readable instructions that, when executed by the processor, cause the processor to: receive an artificial intelligence control setpoint for controlling an operating condition of the industrial process system, compare the artificial intelligence control setpoint to a static threshold and a dynamic threshold, output a control signal, to manipulate the operating condition, as one of the artificial intelligence control setpoint, the static threshold, or the dynamic threshold based on a relationship of the artificial intelligence control setpoint to the static threshold or dynamic threshold.

(A2) In the embodiment (A1), the static threshold includes an upper boundary and a lower boundary.

(A3) In any embodiment (A1)-(A2), the dynamic threshold includes an upper boundary and a lower boundary.

(A4) In any embodiment (A3), the upper and lower bounds of the dynamic threshold are defined by an uncertainty range of a different calculation than a model used to generate the artificial intelligence control setpoint.

(A5) In any embodiment (A4), the different calculation includes a First Principle physics-based calculation.

(A6) In any embodiment (A4), the different calculation includes a subject matter expertise-based statistical calculation.

(A7) In any embodiment (A4), the different calculation includes an advanced simulation boundary calculation.

(A8) In any embodiment (A4), the different calculation including a hybrid of one or more of a First Principle physics-based calculation, a subject matter expertise-based statistical calculation, and an advanced simulation boundary calculation.

(A9) In any embodiment (A3)-(A8), the upper and lower bounds of the dynamic threshold being defined by a recommendation confidence region including calculate the recommendation confidence region defined as P±\sqrt{U_{HW}²+U_{Hist}²}; where P is the value of a target value corresponding to the artificial intelligence control setpoint; U_{HW} is the value of a hardware uncertainty; and U_{Hist} is the value of a historical uncertainty.

(A10) In any embodiment (A1)-(A9), the static threshold defining an error in the measured process data stored within the data historian.

(A11) In any embodiment (A1)-(A10), the control engine including further instructions that, when executed by the processor, further cause the processor to output the control signal to include an alert when the artificial intelligence control setpoint breaches the static threshold.

(A12) In any embodiment (A11), the alert including a command to change control mode of the industrial process system to one or more of: shut down the industrial process system and stop implementing artificial intelligence-based control.

(A13) In any embodiment (A1)-(A12), the control engine located at an on-site edge device.

(A14) In any embodiment (A1)-(A13), the control engine located at a heater controller of a combustion system.

(A15) In any embodiment (A1)-(A14), the control engine located at an off-site server.

(A16) In any embodiment (A1)-(A15), the artificial intelligence control setpoint being received from an off-site server.

(B1) In an embodiment of a second aspect, a method for automated control of an industrial process system includes: receiving an artificial intelligence control setpoint for controlling an operating condition of the industrial process system, comparing the artificial intelligence control setpoint to a static threshold and a dynamic threshold, outputting a control signal, to manipulate the operating condition, as one of the artificial intelligence control setpoint, the static threshold, or the dynamic threshold based on a relationship of the artificial intelligence control setpoint to the static threshold or dynamic threshold.

(B2) In the embodiment (B1), the static threshold includes an upper boundary and a lower boundary.

(B3) In any embodiment (B1)-(B2), the dynamic threshold including an upper boundary and a lower boundary.

(B4) In any embodiment (B1)-(B3), the method further including defining the upper and lower bounds of the dynamic threshold based on an uncertainty range of a different calculation than a model used to generate the artificial intelligence control setpoint.

(B5) In any embodiment (B4), the different calculation being a First Principle physics-based calculation.

(B6) In any embodiment (B4), the different calculation being a subject matter expertise-based statistical calculation.

(B7) In any embodiment (B4), the different calculation being an advanced simulation boundary calculation.

(B8) In any embodiment (B4), the different calculation being a hybrid of one or more of a First Principle physics-based calculation, a subject matter expertise-based statistical calculation, and an advanced simulation boundary calculation.

(B9) In any embodiment (B1)-(B8), the method further including defining the upper and lower bounds of the dynamic threshold based on a recommendation confidence region including calculate the recommendation confidence region defined as P±\sqrt{U_{HW}²+U_{Hist}²}; where P is the value of a target value corresponding to the artificial intelligence control setpoint; U_{HW} is the value of a hardware uncertainty; and U_{Hist} is the value of a historical uncertainty

(B10) In any embodiment (B1)-(B9), the static threshold defining an error in the measured process data stored within the data historian.

(B11) In any embodiment (B1)-(B10), further comprising outputting the control signal including an alert when the artificial intelligence control setpoint breaches the static threshold.

(B12) In any embodiment (B11), the alert including a command to change control mode of a combustion system to one or more of: shut down the combustion system and stop implementing artificial intelligence-based control.

1. A system for automated control of an industrial process system, comprising:
a data historian storing measured process data sensed by a plurality of sensors within the industrial process system;
a processor; and,
memory storing a control engine as computer readable instructions that, when executed by the processor, cause the processor to:
analyze the measured process data stored by the data historian to identify conditions within the industrial process system, and output an artificial intelligence control setpoint using a machine learning routine to control the industrial process system to an operating condition;
receive the artificial intelligence control setpoint for controlling the operating condition of the industrial process system;
compare the artificial intelligence control setpoint to a static threshold and a dynamic threshold; and
output a control signal, to manipulate the operating condition, as one of the artificial intelligence control setpoint, the static threshold, or the dynamic threshold based on a relationship of the artificial intelligence control setpoint to the static threshold or dynamic threshold.

2. The system of claim 1, wherein the static threshold comprises an upper boundary and a lower boundary.

3. The system of claim 1, wherein the dynamic threshold comprises an upper boundary and a lower boundary.

4. The system of claim 3, the upper and lower bounds of the dynamic threshold being defined by an uncertainty range of a different calculation than a model used to generate the artificial intelligence control setpoint.

5. The system of claim 4, the different calculation being a First Principle physics-based calculation.

6. The system of claim 4, the different calculation being a subject matter expertise-based statistical calculation.

7. The system of claim 4, the different calculation being an advanced simulation boundary calculation.

8. The system of claim 4, the different calculation being a hybrid of one or more of a First Principle physics-based calculation, a subject matter expertise-based statistical calculation, and an advanced simulation boundary calculation.

9. The system of claim 3, wherein the upper and lower bounds of the dynamic threshold are defined by a recommendation confidence region, wherein the recommendation confidence region is defined as P±\sqrt{U_{HW}²+U_{Hist}²}; where P is the value of a target value corresponding to the artificial intelligence control setpoint; U_{HW} is the value of a hardware uncertainty; and U_{Hist} is the value of a historical uncertainty.

10. The system of claim 1, the static threshold defining an error in the measured process data stored within the data historian.

11. The system of claim 1, wherein the control engine further comprises instructions that, when executed by the processor, further cause the processor to output the control signal to include an alert when the artificial intelligence control setpoint breaches the static threshold.

12. The system of claim 11, wherein the alert comprises a command to change control mode of the industrial process system to one or more of: shut down the industrial process system and stop implementing artificial intelligence-based control.

13. The system of claim 1, the control engine located at an on-site edge device.

14. The system of claim 1, the control engine located at a heater controller of a combustion system.

15. The system of claim 1, the control engine located at an off-site server.

16. The system of claim 1, the artificial intelligence control setpoint being received from an off-site server implementing the machine learning routine.

17. A method for automated control of an industrial process system, comprising:
analyzing measured process data identify conditions within the industrial process system, and output an artificial intelligence control setpoint using a machine learning routine to control the industrial process system to an operating condition;
accessing the artificial intelligence control setpoint for controlling the operating condition of the industrial process system;
comparing the artificial intelligence control setpoint to a static threshold and a dynamic threshold; and
outputting a control signal, to manipulate the operating condition, as one of the artificial intelligence control setpoint, the static threshold, or the dynamic threshold based on a relationship of the artificial intelligence control setpoint to the static threshold or dynamic threshold.

18. The method of claim 17, wherein the static threshold comprises an upper boundary and a lower boundary.

19. The method of claim 17, wherein the dynamic threshold comprises an upper boundary and a lower boundary.

20. The method of claim 19, further comprising defining the upper and lower bounds of the dynamic threshold based on an uncertainty range of a different calculation than a model used to generate the artificial intelligence control setpoint.

21. The method of claim 20, the different calculation being a First Principle physics-based calculation.

22. The method of claim 20, the different calculation being a subject matter expertise-based statistical calculation.

23. The method of claim 20, the different calculation being an advanced simulation boundary calculation.

24. The method of claim 20, the different calculation being a hybrid of one or more of a First Principle physics-based calculation, a subject matter expertise-based statistical calculation, and an advanced simulation boundary calculation.

25. The method of claim 17, further comprising defining the upper and lower bounds of the dynamic threshold based on a recommendation confidence region, wherein the recommendation confidence region is defined as P±\sqrt{U_{HW}²+U_{Hist}²}; where P is the value of a target value corresponding to the artificial intelligence control setpoint; U_{HW} is the value of a hardware uncertainty; and U_{Hist} is the value of a historical uncertainty.

26. The method of claim 17, the static threshold defining an error in the measured process data stored within the data historian.

27. The method of claim 17, further comprising outputting the control signal as an alert in an instance in which the artificial intelligence control setpoint breaches the static threshold.

28. The method of claim 27, wherein the alert comprises a command to change control mode of a combustion system to one or more of: shut down the combustion system and stop implementing artificial intelligence-based control.
